(19) United States
(12) Patent Application Publication
(10) Pub. No.: US 2023/0419504 A1
(43) Pub. Date: Dec. 28, 2023

(54) IMAGING SUPPORT APPARATUS, IMAGING APPARATUS, IMAGING SUPPORT METHOD, AND PROGRAM

(71) Applicant: FUJIFILM Corporation, Tokyo (JP)

(72) Inventors: Hitoshi SAKURABU, Saitama-shi (JP); Kazuya OKIYAMA, Saitama-shi (JP)

(73) Assignee: FUJIFILM Corporation, Tokyo (JP)

(21) Appl. No.: 18/462,996

(22) Filed: Sep. 7, 2023

Related U.S. Application Data
(63) Continuation of application No. PCT/JP2022/005749, filed on Feb. 14, 2022.

(30) Foreign Application Priority Data
Mar. 19, 2021 (JP) 2021-046615

(51) Int. Cl. G06T 7/20; G06T 5/50; G06T 7/11; G06V 10/764; G06V 10/82; G06F 3/14

(52) U.S. Cl. CPC G06T 7/20; G06T 5/50; G06T 7/11; G06V 10/764; G06V 10/82; G06F 3/14; G06V 2201/07; G06T 2207/20221

(57) ABSTRACT

There is provided an imaging support apparatus including a processor and a memory built into or connected to the processor. The processor inputs a captured image to a neural network to cause the neural network to identify a subject that is included in the captured image, and performs imaging-related processing according to an influence degree on identification with the neural network performed with respect to the captured image.

### CROSS-REFERENCE TO RELATED APPLICATIONS

This application is a continuation application of International Application No. PCT/JP2022/005749 filed Feb. 14, 2022, the disclosure of which is incorporated herein by reference in its entirety. Further, this application claims priority under 35 USC 119 from Japanese Patent Application No. 2021-046615 Mar. 19, 2021, the disclosure of which is incorporated by reference herein.

### BACKGROUND

### 1. Technical Field

The present disclosed technology relates to an imaging support apparatus, an imaging apparatus, an imaging support method, and a program.

### 2. Related Art

JP2019-016114A discloses an image processing apparatus including an extraction unit that extracts a feature amount from a target image and an estimation unit that estimates a mixed state of regions having mutually different attributes in the target image based on the feature amount. Here, one of the regions is a region of a subject belonging to a specific class, and another one of the regions is a region of a subject belonging to a class different from the specific class. Further, the image processing apparatus described in JP2019-016114A further includes an output unit that outputs information indicating the mixed state.

JP2019-016114A discloses a learning apparatus including an extraction unit that extracts a feature amount of identification image used for training an estimator, an acquisition unit that acquires information indicating a mixed state of regions having mutually different attributes in the identification image as training information, and a learning unit that performs training of the estimator, which estimates the mixed state from the feature amount, using a combination of the feature amount of the identification image and the training information.

JP2019-016114A discloses a focus control device that is a focus control device for an imaging apparatus including a plurality of distance measurement points and that includes an acquisition unit that acquires information indicating an area ratio of a region of a specific attribute to a region for the region corresponding to each of the plurality of distance measurement points in an image obtained by the imaging apparatus, and a control unit that weights the plurality of distance measurement points according to the area ratio and that performs focus control of the imaging apparatus.

JP2019-016114A describes an exposure control device including an acquisition unit that acquires an image obtained by the imaging apparatus and information indicating the area ratio of the region of the specific attribute to the region for each region in the image, a calculation unit that calculates the area ratio of the region of the specific attribute to the entire image, a selection unit that selects an exposure control algorithm according to the area ratio calculated by the calculation unit, and a control unit that performs exposure control of the imaging apparatus by using the selected exposure control algorithm.

JP2019-186918A describes an image processing apparatus including a subject detection unit that applies subject detection processing to an image by using a parameter generated based on machine learning, a storage unit that stores a plurality of parameters used for the subject detection processing, and a selection unit that selects the parameter to be used by the subject detection unit from the parameters stored in the storage unit according to characteristics of the image to which subject detection processing is applied. Here, the selection unit selects a learning model to be used by the subject detection unit according to an imaging element in which the image is generated. Further, a convolutional neural network is used for the machine learning.

JP2019-125204A discloses a target recognition apparatus including a convolutional neural network that is obtained by training, which uses a plurality of learning data obtained by combining a learning image in which at least one of a plurality of targets of different types is imaged and training data indicating a type, position, and orientation of the target in the learning image, a convolutional neural network unit that uses the convolutional neural network to generate a score map related to the target from an input image for each pixel of the input image, and an acquisition unit that acquires target recognition information indicating the type, position, and orientation of at least one target imaged in the input image based on the score map, in which in the training where the convolutional neural network is obtained, the orientation of the target indicated by training data included in at least one learning data, among the plurality of learning data, is changed, and new learning data in which a modified image, which is obtained by modifying an image of the target in the learning image according to the changed orientation of the target, and the type, position, and changed orientation of the target are combined, and a plurality of learning data are used.

In the target recognition apparatus described in JP2019-125204A, the orientation of the target in the training data is indicated by different classes assigned to a front side and rear side of the target, and the acquisition unit acquires the position and orientation of at least one target imaged in the input image based on respective scores of the front side and the rear side of the target in the score map. Further, the convolutional neural network includes two or more hidden layers having a plurality of convolutional filters, each of the plurality of convolutional filters scans the input image to calculate a feature amount for each partial region of the input image, and a score map having the same size as the input image is generated based on the feature amount calculated for each partial region.

### SUMMARY

One embodiment according to the present disclosed technology provides an imaging support apparatus, an imaging apparatus, an imaging support method, and a program capable of contributing to realization of imaging suitable for a subject as compared with a case where control related to the imaging is performed using only information irrelevant to an influence degree on identification with a neural network performed with respect to a captured image.

An imaging support apparatus of a first aspect according to the present disclosed technology comprises: a processor; and a memory built into or connected to the processor, in which the processor is configured to: input a captured image to a neural network to cause the neural network to identify a subject that is included in the captured image; and perform imaging-related processing according to an influence degree on identification with the neural network performed with respect to the captured image.

A second aspect according to the present disclosed technology is the imaging support apparatus according to the first aspect, in which the processor is configured to perform division processing of dividing the captured image into a plurality of regions according to the influence degree.

A third aspect according to the present disclosed technology is the imaging support apparatus according to the second aspect, in which the imaging-related processing includes first processing of outputting first data for displaying the plurality of regions on a first display in different manners according to the influence degree.

A fourth aspect according to the present disclosed technology is the imaging support apparatus according to the third aspect, in which the first data is data for displaying the captured image on the first display and data for displaying the plurality of regions in a state of being combined with the captured image in different manners according to the influence degree.

A fifth aspect according to the present disclosed technology is the imaging support apparatus according to any one of the second to fourth aspects, in which the imaging-related processing includes second processing on a first region that corresponds to a region, from among the plurality of regions, having the influence degree equal to or higher than a first threshold value.

A sixth aspect according to the present disclosed technology is the imaging support apparatus according to any one of the second to fifth aspects, in which the imaging-related processing includes third processing using data, as a reference, related to a region, from among the plurality of regions, having the influence degree equal to or higher than a second threshold value.

A seventh aspect according to the present disclosed technology is the imaging support apparatus according to any one of the second to sixth aspects, in which the processor is configured to perform the imaging-related processing based on a classification result obtained by classifying the plurality of regions according to the influence degree.

An eighth aspect according to the present disclosed technology is the imaging support apparatus according to the seventh aspect, in which the processor is configured to perform detection processing of detecting a target subject based on the captured image and tracking processing of tracking the target subject based on the captured image, and the imaging-related processing includes fourth processing of performing the tracking processing based on the classification result in a case where detection of the target subject using the detection processing is interrupted.

A ninth aspect according to the present disclosed technology is the imaging support apparatus according to any one of the first to eighth aspects, in which the processor is configured to selectively perform detection processing of detecting a target subject based on the captured image and tracking processing of tracking the target subject based on the captured image, and the imaging-related processing includes fifth processing of switching from the detection processing to the tracking processing in a case where the influence degree is equal to or higher than a third threshold value.

A tenth aspect according to the present disclosed technology is the imaging support apparatus according to any one of the first to eighth aspects, in which the processor is configured to selectively perform detection processing of detecting a target subject based on the captured image and tracking processing of tracking the target subject based on the captured image, and the imaging-related processing includes fifth processing of switching from the detection processing to the tracking processing based on a distribution state in which the influence degree in the captured image is equal to or higher than a third threshold value.

An eleventh aspect according to the present disclosed technology is the imaging support apparatus according to any one of the eighth to tenth aspects, in which a tracking target region where a tracking target is specifiable using the tracking processing is narrower than a detection target region where a detection target is specifiable using the detection processing.

A twelfth aspect according to the present disclosed technology is the imaging support apparatus according to the eleventh aspect, in which the imaging-related processing includes sixth processing of outputting second data for displaying, on a second display, a first composite image, which is obtained by combining the captured image and detection target region specification information in which the detection target region is specifiable, and a second composite image, which is obtained by combining the captured image and tracking target region specification information in which the tracking target region is specifiable.

A thirteenth aspect according to the present disclosed technology is the imaging support apparatus according to the twelfth aspect, in which the detection target region specification information is information including a first frame in which the detection target region is specifiable, and the tracking target region specification information is information including a second frame in which the tracking target region is specifiable.

A fourteenth aspect according to the present disclosed technology is the imaging support apparatus according to any one of the first to thirteenth aspects, in which in a case where the captured image includes a plurality of subject images showing a plurality of subjects, the imaging-related processing includes seventh processing of selecting one subject from among the plurality of subjects based on at least one of the influence degree or a distribution state of the influence degrees.

A fifteenth aspect according to the present disclosed technology is the imaging support apparatus according to the fourteenth aspect, in which the plurality of subjects are subjects of the same type.

A sixteenth aspect according to the present disclosed technology is the imaging support apparatus according to any one of the first to fifteenth aspects, in which the processor is configured to cause the neural network to identify a single subject class.

A seventeenth aspect according to the present disclosed technology is the imaging support apparatus according to any one of the first to sixteenth aspects, in which the processor is configured to perform first periodic processing of causing the neural network to identify the subject in a first period and second periodic processing of causing the neural network to identify the subject in a second period, which is longer than the first period, according to the influence degree.

An eighteenth aspect according to the present disclosed technology is the imaging support apparatus according to any one of the first to seventeenth aspects, in which the influence degree is derived based on an output of an interlayer of the neural network.

A nineteenth aspect according to the present disclosed technology is the imaging support apparatus according to any one of the first to eighteenth aspects, in which the neural network includes a plurality of interlayers, and the influence degree is derived based on an output of an interlayer selected from the plurality of interlayers.

An imaging apparatus of a twentieth aspect according to the present disclosed technology comprises: a processor; and an image sensor, in which the processor is configured to: input a captured image, which is obtained by being captured by the image sensor, to a neural network to cause the neural network to identify a subject that is included in the captured image as an image; and perform imaging-related processing according to an influence degree on identification with the neural network performed with respect to the captured image.

An imaging support method of a twenty-first aspect according to the present disclosed technology comprises: inputting a captured image to a neural network to cause the neural network to identify a subject that is included in the captured image as an image; and performing imaging-related processing according to an influence degree on identification with the neural network performed with respect to the captured image.

A program of a twenty-second aspect according to the present disclosed technology that causes a computer to execute a process comprises: inputting a captured image to a neural network to cause the neural network to identify a subject that is included in the captured image as an image; and performing imaging-related processing according to an influence degree on identification with the neural network performed with respect to the captured image.

### BRIEF DESCRIPTION OF THE DRAWINGS

Exemplary embodiments of the technology of the disclosure will be described in detail based on the following figures, wherein:

FIG. 1 is a schematic configuration diagram showing an example of a configuration of an entire imaging apparatus;

FIG. 2 is a schematic configuration diagram showing an example of hardware configurations of an optical system and an electrical system of the imaging apparatus;

FIG. 3 is a block diagram showing an example of a storage content of an NVM and a function of a main part of a CPU;

FIG. 4 is a conceptual diagram showing an example of a content of processing of identification unit, a division processing unit, and an imaging-related processing unit;

FIG. 5 is a conceptual diagram showing an example of a layer structure of a neural network;

FIG. 6 is a conceptual diagram showing an example of a content of processing of the division processing unit in a case where one channel conversion is performed on a plurality of channels of feature maps by using a back propagation calculation;

FIG. 7 is a conceptual diagram showing an example of processing of generating a CAM image through the division processing unit;

FIG. 8 is a block diagram showing an example of a function included in the imaging-related processing unit;

FIG. 9 is a conceptual diagram showing an example of a content of first processing performed by a first processing unit;

FIG. 10 is a conceptual diagram showing an example of a content of second processing performed by a second processing unit;

FIG. 11 is a screen view showing an example of a mode in which an entire detection frame according to a comparative example is displayed on a display, and an example of a mode in which a local detection frame according to an embodiment is displayed on the display;

FIG. 12 is a screen view showing an example of a mode in which a plurality of local detection frames are displayed on the display;

FIG. 13 is a conceptual diagram showing an example of a content of third processing performed by a third processing unit;

FIG. 14 is a conceptual diagram showing an example of a content of fourth processing performed by a fourth processing unit;

FIG. 15 is a conceptual diagram showing an example of a known tracking frame in the related art;

FIG. 16 is a conceptual diagram showing an example of a content of tracking processing included in the fourth processing performed by the fourth processing unit;

FIG. 17 is a conceptual diagram showing an example of a content of fifth processing performed by a fifth processing unit;

FIG. 18 is a conceptual diagram showing an example of a content of sixth processing performed by a sixth processing unit;

FIG. 19 is a flowchart showing an example of a flow of imaging support processing;

FIG. 20 is a block diagram showing an example of a function included in an imaging-related processing unit according to a first modification example;

FIG. 21 is a conceptual diagram showing an example of a content of processing of identification unit according to the first modification example;

FIG. 22 is a conceptual diagram showing an example of a content of processing of a division processing unit according to the first modification example;

FIG. 23 is a conceptual diagram showing an example of a content of seventh processing performed by a seventh processing unit according to the first modification example;

FIG. 24 is a conceptual diagram showing an example of a content of processing of identification unit according to a second modification example;

FIG. 25 is a conceptual diagram showing an example of a content of seventh processing performed by a seventh processing unit according to the second modification example;

FIG. 26 is a conceptual diagram showing an example of a content of processing of identification unit according to a third modification example;

FIG. 27 is a schematic configuration diagram showing an example of a configuration of an imaging system; and

FIG. 28 is a block diagram showing an example of a mode in which an imaging support processing program, which is stored in a storage medium, is installed in a controller.

### DETAILED DESCRIPTION

Hereinafter, an example of an embodiment of an imaging support apparatus, an imaging apparatus, an imaging support method, and a program according to the present disclosed technology will be described with reference to the accompanying drawings.

First, the wording used in the following description will be described.

CPU refers to an abbreviation of a “Central Processing Unit”. GPU refers to an abbreviation of a “Graphics Processing Unit”. GPGPU refers to an abbreviation of a “General-purpose computing on graphics processing units”. TPU refers to an abbreviation of a “Tensor processing unit”. NVM refers to an abbreviation of a “Non-volatile memory”. RAM refers to an abbreviation of a “Random Access Memory”. IC refers to an abbreviation of an “Integrated Circuit”. ASIC refers to an abbreviation of an “Application Specific Integrated Circuit”. PLD refers to an abbreviation of a “Programmable Logic Device”. FPGA refers to an abbreviation of a “Field-Programmable Gate Array”. SoC refers to an abbreviation of a “System-on-a-chip”. SSD refers to an abbreviation of a “Solid State Drive”. USB refers to an abbreviation of a “Universal Serial Bus”. HDD refers to an abbreviation of a “Hard Disk Drive”. EEPROM refers to an abbreviation of an “Electrically Erasable and Programmable Read Only Memory”. EL refers to an abbreviation of “Electro-Luminescence”. I/F refers to an abbreviation of an “Interface”. UI refers to an abbreviation of a “User Interface”. fps refers to an abbreviation of a “frame per second”. MF refers to an abbreviation of “Manual Focus”. AF refers to an abbreviation of “Auto Focus”. CMOS refers to an abbreviation of a “Complementary Metal Oxide Semiconductor”. LAN refers to an abbreviation of a “Local Area Network”. WAN refers to an abbreviation of a “Wide Area Network”. AI refers to an abbreviation of “Artificial Intelligence”. TOF refers to an abbreviation of “Time Of Flight”. CAM refers to an abbreviation of “Class Activation Mapping”. RELU refers to an abbreviation of “Rectified Linear Unit”.

In the description of the present specification, the “coincidence” indicates a coincidence in the sense of including an error generally allowed in the technical field, to which the present disclosed technology belongs, in addition to the perfect coincidence, and an error that does not go against the gist of the present disclosed technology. Further, in the description of the present specification, a numerical range represented by using “˜” means a range including numerical values before and after “˜” as the lower limit value and the upper limit value.

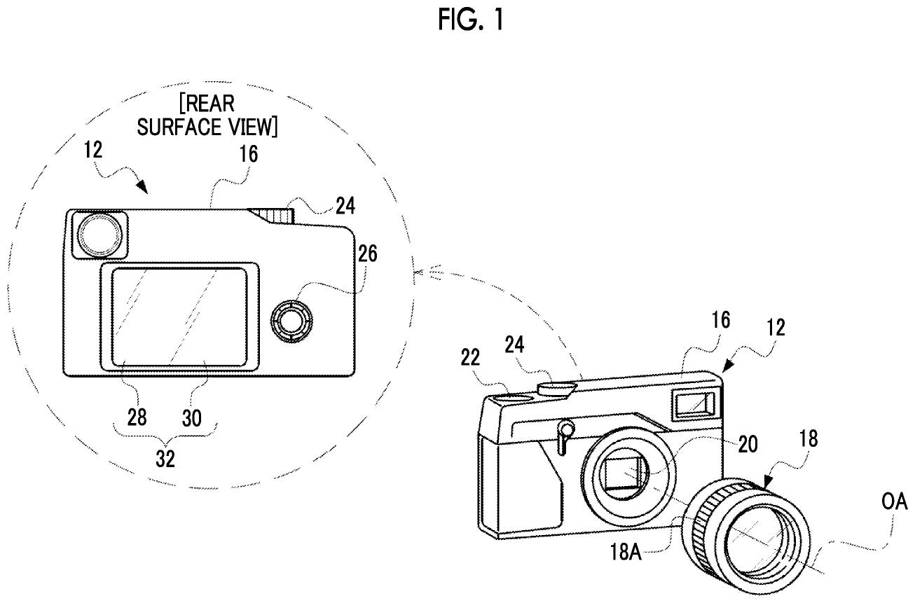

As an example shown in FIG. 1, an imaging apparatus 12 includes an imaging apparatus main body 16 and an imaging lens 18, and images a subject. In the example shown in FIG. 1, a lens-interchangeable digital camera is shown as an example of the imaging apparatus 12. The imaging lens 18 is interchangeably attached to the imaging apparatus main body 16. The imaging lens 18 is provided with a focus ring 18A. In a case where a user or the like of the imaging apparatus 12 (hereinafter, simply referred to as the “user”) manually adjusts the focus on the subject through the imaging apparatus 12, the focus ring 18A is operated by the user or the like.

In the present embodiment, although the lens-interchangeable digital camera is exemplified as the imaging apparatus 12, this is only an example, and a digital camera with a fixed lens may be used or a digital camera, which is built into various electronic devices such as a smart device, a wearable terminal, a cell observation device, an ophthalmologic observation device, or a surgical microscope may be used.

An image sensor 20 is provided in the imaging apparatus main body 16. The image sensor 20 is a CMOS image sensor. The image sensor 20 captures an imaging range including at least one subject. In a case where the imaging lens 18 is attached to the imaging apparatus main body 16, subject light indicating the subject is transmitted through the imaging lens 18 and imaged on the image sensor 20, and then image data indicating an image, which includes the subject as a subject image, is generated by the image sensor 20. In the present embodiment, although the CMOS image sensor is exemplified as the image sensor 20, the present disclosed technology is not limited to this, and other image sensors may be used.

A release button 22 and a dial 24 are provided on an upper surface of the imaging apparatus main body 16. The dial 24 is operated in a case where an operation mode of the imaging system, an operation mode of a playback system, and the like are set, and by operating the dial 24, an imaging mode and a playback mode are selectively set as the operation mode in the imaging apparatus 12.

The release button 22 functions as an imaging preparation instruction unit and an imaging instruction unit, and is capable of detecting a two-step pressing operation of an imaging preparation instruction state and an imaging instruction state. The imaging preparation instruction state refers to a state in which the release button 22 is pressed, for example, from a standby position to an intermediate position (half pressed position), and the imaging instruction state refers to a state in which the release button 22 is pressed to a final pressed position (fully pressed position) beyond the intermediate position. In the following, the “state of being pressed from the standby position to the half pressed position” is referred to as a “half pressed state”, and the “state of being pressed from the standby position to the fully pressed position” is referred to as a “fully pressed state”. Depending on the configuration of the imaging apparatus 12, the imaging preparation instruction state may be a state in which the user's finger is in contact with the release button 22, and the imaging instruction state may be a state in which the operating user's finger is moved from the state of being in contact with the release button 22 to the state of being away from the release button 22.

A touch panel display 32 and an instruction key 26 are provided on a rear surface of the imaging apparatus main body 16.

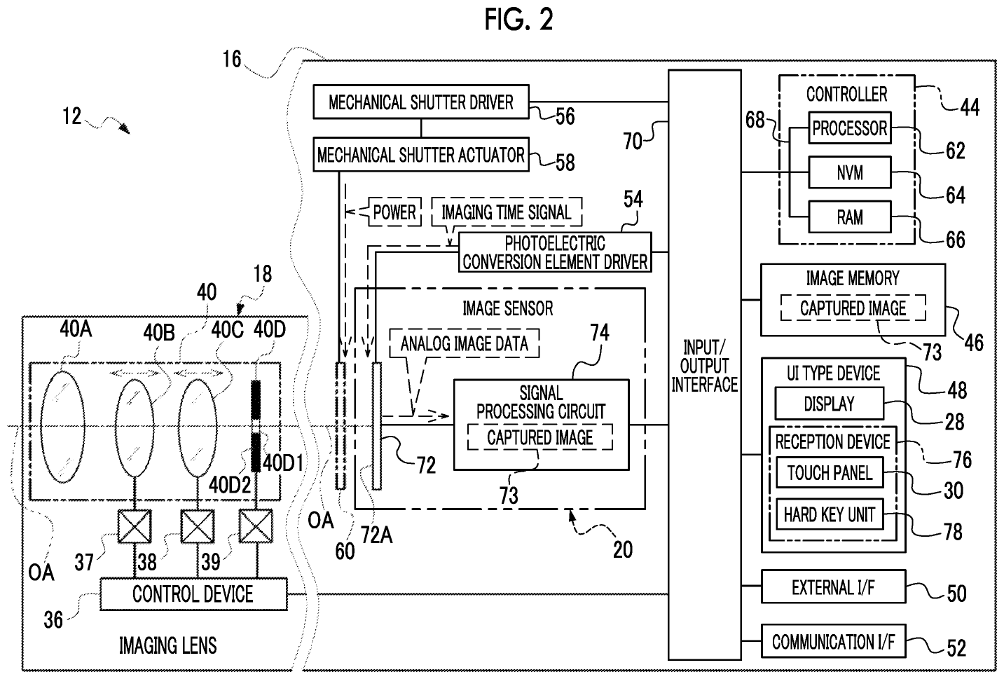

The touch panel display 32 includes a display 28 and a touch panel 30 (see also FIG. 2). The display 28 is an example of a “first display” and a “second display” according to the present disclosed technology.

Examples of the display 28 include an EL display (for example, an organic EL display or an inorganic EL display). The display 28 may not be an EL display but may be another type of display such as a liquid crystal display.

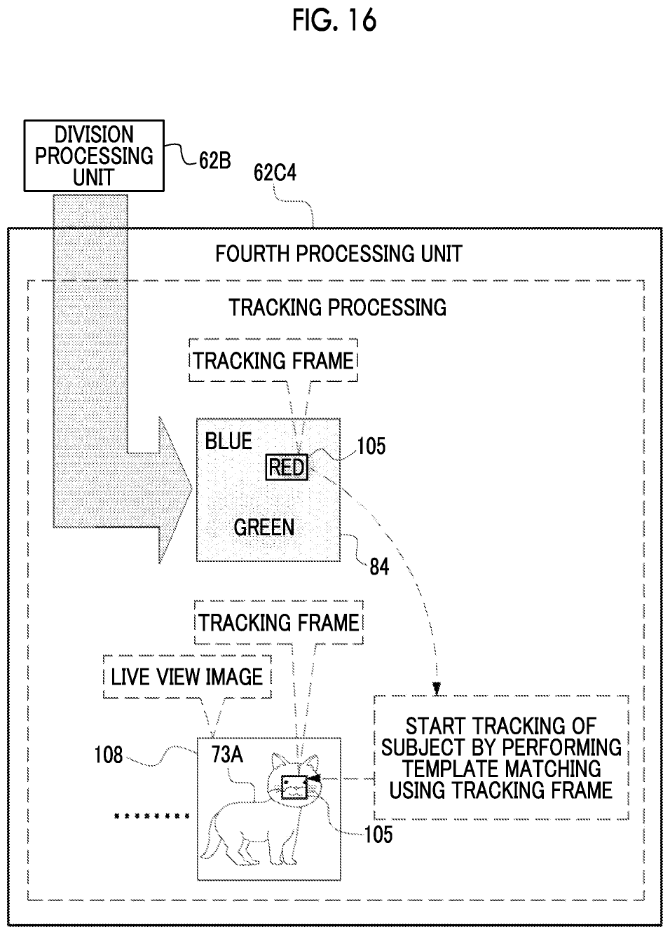

The display 28 displays image and/or character information and the like. The display 28 is used for imaging for a live view image, that is, for displaying a live view image 108 (see FIG. 16) obtained by performing the continuous imaging in a case where the imaging apparatus 12 is in the imaging mode. Here, the live view image 108 image refers to a moving image for display based on the image data obtained by being imaged by the image sensor 20. The imaging, which is performed to obtain the live view image 108 (hereinafter, also referred to as “imaging for a live view image”), is performed according to, for example, a frame rate of 60 fps. 60 fps is only an example, and a frame rate of fewer than 60 fps may be used, or a frame rate of more than 60 fps may be used.

The display 28 is also used for displaying a still image obtained by the imaging for a still image in a case where an instruction for performing the imaging for a still image is provided to the imaging apparatus 12 via the release button 22. Further, the display 28 is also used for displaying a playback image and displaying a menu screen or the like in a case where the imaging apparatus 12 is in the playback mode.

The touch panel 30 is a transmissive touch panel and is superimposed on a surface of a display region of the display 28. The touch panel 30 receives the instruction from the user by detecting contact with an indicator such as a finger or a stylus pen. In the following, for convenience of explanation, the above-mentioned “fully pressed state” also includes a state in which the user turns on a softkey for starting the imaging via the touch panel 30.

Further, in the present embodiment, although an out-cell type touch panel display in which the touch panel 30 is superimposed on the surface of the display region of the display 28 is exemplified as an example of the touch panel display 32, this is only an example. For example, as the touch panel display 32, an on-cell type or in-cell type touch panel display can also be applied.

The instruction key 26 receives various instructions. Here, the “various instructions” refer to, for example, various instructions such as an instruction for displaying the menu screen from which various menus can be selected, an instruction for selecting one or a plurality of menus, an instruction for confirming a selected content, an instruction for erasing the selected content, zooming in, zooming out, frame forwarding, and the like. Further, these instructions may be provided by the touch panel 30.

As an example shown in FIG. 2, the image sensor 20 includes photoelectric conversion elements 72. The photoelectric conversion elements 72 have a light-receiving surface 72A. The photoelectric conversion elements 72 are disposed in the imaging apparatus main body 16 such that the center of the light-receiving surface 72A and an optical axis OA coincide with each other (see also FIG. 1). The photoelectric conversion elements 72 have a plurality of photosensitive pixels arranged in a matrix shape, and the light-receiving surface 72A is formed by the plurality of photosensitive pixels. The photosensitive pixel is a physical pixel having a photodiode (not shown), which photoelectrically converts the received light and outputs an electric signal according to the light receiving amount.

The imaging lens 18 includes an imaging optical system 40. The imaging optical system 40 has an objective lens 40A, a focus lens 40B, a zoom lens 40C, and a stop 40D. The objective lens 40A, the focus lens 40B, the zoom lens 40C, and the stop 40D are disposed in the order of the objective lens 40A, the focus lens 40B, the zoom lens 40C, and the stop 40D along the optical axis OA from the subject side (object side) to the imaging apparatus main body 16 side (image side).

Further, the imaging lens 18 includes a control device 36, a first actuator 37, a second actuator 38, and a third actuator 39. The control device 36 controls the entire imaging lens 18 according to the instruction from the imaging apparatus main body 16. The control device 36 is a device having a computer including, for example, a CPU, an NVM, a RAM, and the like. Although a computer is exemplified here, this is only an example, and a device including an ASIC, FPGA, and/or PLD may be applied. Further, as the control device 36, for example, a device implemented by a combination of a hardware configuration and a software configuration may be used.

The first actuator 37 includes a slide mechanism for focus (not shown) and a motor for focus (not shown). The focus lens 40B is attached to the slide mechanism for focus to be slidable along the optical axis OA. Further, the motor for focus is connected to the slide mechanism for focus, and the slide mechanism for focus operates by receiving the power of the motor for focus to move the focus lens 40B along the optical axis OA.

The second actuator 38 includes a slide mechanism for zoom (not shown) and a motor for zoom (not shown). The zoom lens 40C is attached to the slide mechanism for zoom to be slidable along the optical axis OA. Further, the motor for zoom is connected to the slide mechanism for zoom, and the slide mechanism for zoom operates by receiving the power of the motor for zoom to move the zoom lens 40C along the optical axis OA.

Here, although an example of the embodiment in which the slide mechanism for focus and the slide mechanism for zoom are provided separately has been described, this is only an example, and it may be an integrated type slide mechanism capable of realizing both focusing and zooming. Further, in this case, the power, which is generated by one motor, may be transmitted to the slide mechanism without using a motor for focus and a motor for zoom.

The third actuator 39 includes a power transmission mechanism (not shown) and a motor for stop (not shown). The stop 40D has an opening 40D1 and is a stop in which the size of the opening 40D1 is variable. The opening 40D1 is formed by a plurality of stop leaf blades 40D2. The plurality of stop leaf blades 40D2 are connected to the power transmission mechanism. Further, the motor for stop is connected to the power transmission mechanism, and the power transmission mechanism transmits the power of the motor for stop to the plurality of stop leaf blades 40D2. The plurality of stop leaf blades 40D2 receives the power that is transmitted from the power transmission mechanism and changes the size of the opening 40D1 by being operated. The stop 40D adjusts the exposure by changing the size of the opening 40D1.

The motor for focus, the motor for zoom, and the motor for stop are connected to the control device 36, and the control device 36 controls each drive of the motor for focus, the motor for zoom, and the motor for stop. In the present embodiment, a stepping motor is adopted as an example of the motor for focus, the motor for zoom, and the motor for stop. Therefore, the motor for focus, the motor for zoom, and the motor for stop operate in synchronization with a pulse signal in response to a command from the control device 36. Although an example in which the motor for focus, the motor for zoom, and the motor for stop are provided in the imaging lens 18 has been described here, this is only an example, and at least one of the motor for focus, the motor for zoom, or the motor for stop may be provided in the imaging apparatus main body 16. The constituent and/or operation method of the imaging lens 18 can be changed as needed.

The imaging lens 18 includes a first sensor (not shown). The first sensor detects a position of the focus lens 40B on the optical axis OA. An example of the first sensor includes a potential meter. A detection result, which is obtained by the first sensor, is acquired by the control device 36 and is output to the imaging apparatus main body 16. The imaging apparatus main body 16 adjusts the position of the focus lens 40B on the optical axis OA based on the detection result obtained by the first sensor.

The imaging lens 18 includes a second sensor (not shown). The second sensor detects a position of the zoom lens 40C on the optical axis OA. An example of the second sensor includes a potential meter. A detection result, which is obtained by the second sensor, is acquired by the control device 36 and is output to the imaging apparatus main body 16. The imaging apparatus main body 16 adjusts the position of the zoom lens 40C on the optical axis OA based on the detection result obtained by the second sensor.

The imaging lens 18 includes a third sensor (not shown). The third sensor detects the size of the opening 40D1. An example of the third sensor includes a potential meter. A detection result, which is obtained by the third sensor, is acquired by the control device 36 and is output to the imaging apparatus main body 16. The imaging apparatus main body 16 adjusts the size of the opening 40D1 based on the detection result obtained by the third sensor.

In the imaging apparatus 12, in the case of the imaging mode, an MF mode and an AF mode are selectively set according to the instructions provided to the imaging apparatus main body 16. The MF mode is an operation mode for manually focusing. In the MF mode, for example, by operating the focus ring 18A or the like by the user, the focus lens 40B is moved along the optical axis OA with the movement amount according to the operation amount of the focus ring 18A or the like, thereby the focus is adjusted.

In the AF mode, the imaging apparatus main body 16 calculates a focusing position according to a subject distance and adjusts the focus by moving the focus lens 40B toward the calculated focusing position. Here, the focusing position refers to a position of the focus lens 40B on the optical axis OA in a state in which the target subject is in focus. In the present embodiment, the processing of adjusting the focus in the AF mode is also referred to as “focus control”.

The imaging apparatus main body 16 includes the image sensor 20, a controller 44, an image memory 46, a UI type device 48, an external I/F 50, a communication I/F 52, a photoelectric conversion element driver 54, a mechanical shutter driver 56, a mechanical shutter actuator 58, a mechanical shutter 60, and an input/output interface 70. Further, the image sensor 20 includes the photoelectric conversion elements 72 and a signal processing circuit 74.

The controller 44, the image memory 46, the UI type device 48, the external I/F 50, the photoelectric conversion element driver 54, the mechanical shutter driver 56, and the signal processing circuit 74 are connected to the input/output interface 70. Further, the control device 36 of the imaging lens 18 is also connected to the input/output interface 70.

The controller 44 includes a processor 62, an NVM 64, and a RAM 66. The processor 62, the NVM 64, and the RAM 66 are connected via a bus 68, and the bus 68 is connected to the input/output interface 70. Here, the controller 44 is an example of an “imaging support apparatus” and a “computer” according to the present disclosed technology, the processor 62 is an example of a “processor” according to the present disclosed technology, and the RAM 66 is an example of a “memory” according to the present disclosed technology.

In the example shown in FIG. 2, one bus is shown as the bus 68 for convenience of illustration, but a plurality of buses may be used. The bus 68 may be a serial bus or may be a parallel bus including a data bus, an address bus, a control bus, and the like.

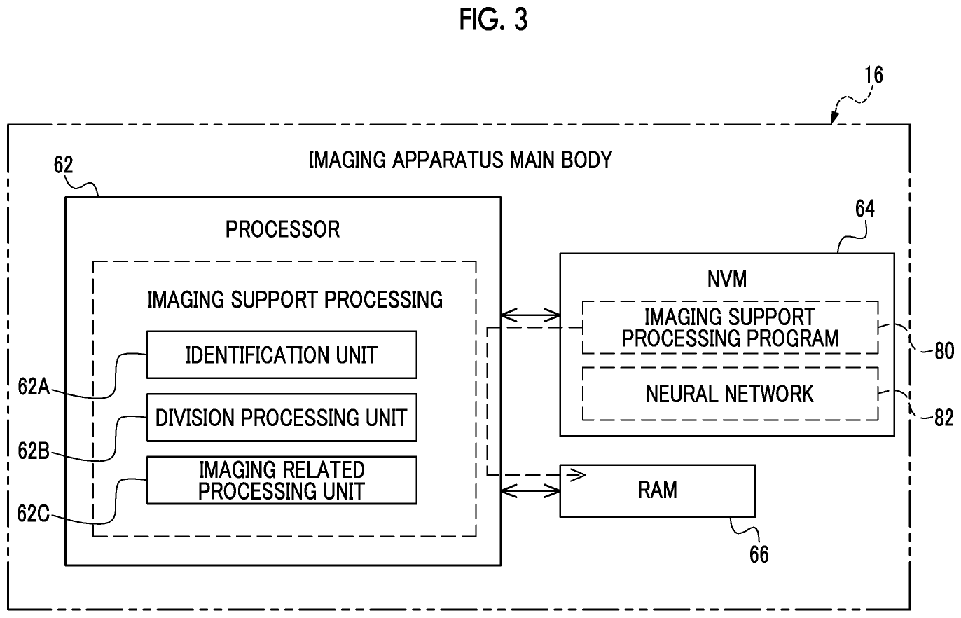

The processor 62 includes, for example, a CPU and a GPU. The GPU is operated under the control of the CPU, and is responsible for executing processing related to an image. The processing, which is related to the image, also includes processing using a neural network 82 (see FIG. 3) described later.

The NVM 64 is a non-temporary storage medium that stores various parameters and various programs. For example, the NVM 64 is an EEPROM. However, this is only an example, and an HDD and/or SSD or the like may be applied as the NVM 64 instead of or together with the EEPROM. Further, the RAM 66 temporarily stores various types of information and is used as a work memory.

The processor 62 reads out a necessary program from the NVM 64 and executes the read program in the RAM 66. The processor 62 controls the entire imaging apparatus 12 according to the program executed on the RAM 66. In the example shown in FIG. 2, the image memory 46, the UI type device 48, the external I/F 50, the communication I/F 52, the photoelectric conversion element driver 54, the mechanical shutter driver 56, and the control device 36 are controlled by the processor 62.

The photoelectric conversion element driver 54 is connected to the photoelectric conversion elements 72. The photoelectric conversion element driver 54 supplies an imaging time signal, which defines a time at which the imaging is performed by the photoelectric conversion elements 72, to the photoelectric conversion elements 72 according to an instruction from the processor 62. The photoelectric conversion elements 72 perform reset, exposure, and output of an electric signal according to the imaging time signal supplied from the photoelectric conversion element driver 54. Examples of the imaging time signal include a vertical synchronization signal, and a horizontal synchronization signal.

In a case where the imaging lens 18 is attached to the imaging apparatus main body 16, the subject light incident on the imaging optical system 40 is imaged on the light-receiving surface 72A by the imaging optical system 40. Under the control of the photoelectric conversion element driver 54, the photoelectric conversion elements 72 photoelectrically convert the subject light, which is received from the light-receiving surface 72A, and output the electric signal corresponding to the amount of light of the subject light to the signal processing circuit 74 as analog image data indicating the subject light. Specifically, the signal processing circuit 74 reads out the analog image data from the photoelectric conversion elements 72 in units of one frame and for each horizontal line by using an exposure sequential reading out method.

The signal processing circuit 74 generates digital image data by digitizing the analog image data. In the following, for convenience of explanation, in a case where it is not necessary to distinguish between digital image data to be internally processed in the imaging apparatus main body 16 and an image indicated by the digital image data (that is, an image that is visualized based on the digital image data and displayed on the display 28 or the like), it is referred to as a “captured image 73”.

The mechanical shutter 60 is a focal plane shutter and is disposed between the stop 40D and the light-receiving surface 72A. The mechanical shutter 60 includes a front curtain (not shown) and a rear curtain (not shown). Each of the front curtain and the rear curtain includes a plurality of leaf blades. The front curtain is disposed closer to the subject side than the rear curtain.

The mechanical shutter actuator 58 is an actuator having a link mechanism (not shown), a solenoid for a front curtain (not shown), and a solenoid for a rear curtain (not shown). The solenoid for a front curtain is a drive source for the front curtain and is mechanically connected to the front curtain via the link mechanism. The solenoid for a rear curtain is a drive source for the rear curtain and is mechanically connected to the rear curtain via the link mechanism. The mechanical shutter driver 56 controls the mechanical shutter actuator 58 according to the instruction from the processor 62.

The solenoid for a front curtain generates power under the control of the mechanical shutter driver 56 and selectively performs winding up and pulling down the front curtain by applying the generated power to the front curtain. The solenoid for a rear curtain generates power under the control of the mechanical shutter driver 56 and selectively performs winding up and pulling down the rear curtain by applying the generated power to the rear curtain. In the imaging apparatus 12, the exposure amount with respect to the photoelectric conversion elements 72 is controlled by controlling the opening and closing of the front curtain and the opening and closing of the rear curtain by the processor 62.

In the imaging apparatus 12, the imaging for a live view image and the imaging for a recorded image for recording the still image and/or the moving image are performed by using the exposure sequential reading out method (rolling shutter method). The image sensor 20 has an electronic shutter function, and the imaging for a live view image is implemented by achieving an electronic shutter function without operating the mechanical shutter 60 in a fully open state.

In contrast to this, the imaging accompanied by the main exposure, that is, the imaging for a still image is implemented by achieving the electronic shutter function and operating the mechanical shutter 60 to shift the mechanical shutter 60 from a front curtain closed state to a rear curtain closed state.

The image memory 46 stores the captured image 73 generated by the signal processing circuit 74. That is, the signal processing circuit 74 stores the captured image 73 in the image memory 46. The processor 62 acquires a captured image 73 from the image memory 46 and executes various processes by using the acquired captured image 73.

The UI type device 48 includes a display 28, and the processor 62 displays various types of information on the display 28. Further, the UI type device 48 includes a reception device 76. The reception device 76 includes a touch panel 30 and a hard key unit 78. The hard key unit 78 is a plurality of hard keys including an instruction key 26 (see FIG. 1). The processor 62 operates according to various types of instructions received by using the touch panel 30. Here, although the hard key unit 78 is included in the UI type device 48, the present disclosed technology is not limited to this, for example, the hard key unit 78 may be connected to the external I/F 50.

The external I/F 50 controls the exchange of various information between the imaging apparatus 12 and an apparatus existing outside the imaging apparatus 12 (hereinafter, also referred to as an “external apparatus”). Examples of the external I/F 50 include a USB interface. The external apparatus (not shown) such as a smart device, a personal computer, a server, a USB memory, a memory card, and/or a printer is directly or indirectly connected to the USB interface.

The communication I/F 52 controls exchange of information between the processor 62 and external apparatuses such as servers, personal computers, and/or smart devices (not shown) via a network (not shown) such as LAN and/or WAN. For example, the communication I/F 52 transmits the information in response to a request from the processor 62 to the external apparatus via the network. Further, the communication I/F 52 receives the information transmitted from the external apparatus and outputs the received information to the processor 62 via the input/output interface 70.

As an example shown in FIG. 3, the NVM 64 stores an imaging support processing program 80 and a neural network 82. The imaging support processing program 80 is an example of a “program” according to the present disclosed technology, and the neural network 82 is an example of a “neural network” according to the present disclosed technology.

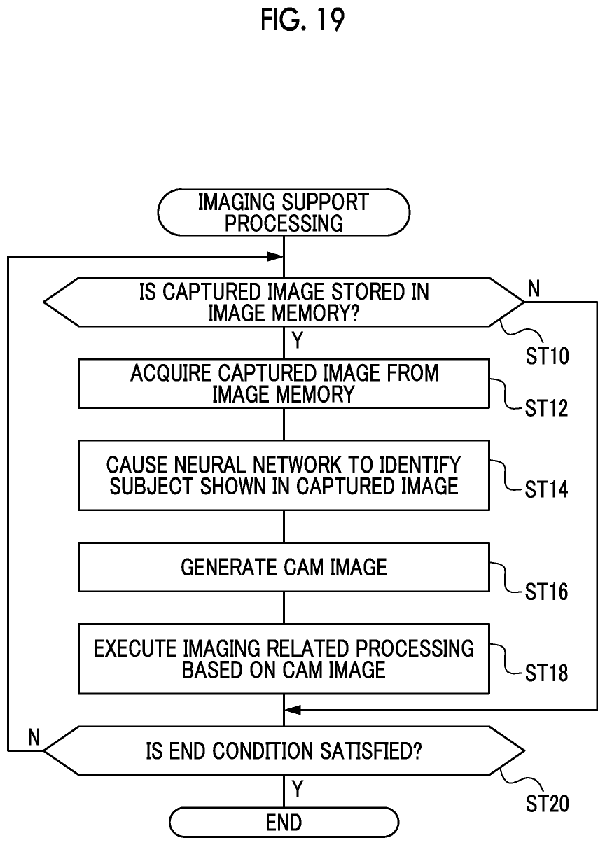

The processor 62 reads out the imaging support processing program 80 from the NVM 64 and executes the read imaging support processing program 80 on the RAM 66. The processor 62 performs the imaging support processing according to the imaging support processing program 80 executed on the RAM 66 (see FIG. 19). The processor 62 operates as the identification unit 62A, the division processing unit 62B, and the imaging-related processing unit 62C by executing the imaging support processing program 80.

The neural network 82 is a trained model generated by being optimized by machine learning. Here, a convolutional neural network is applied as an example of the neural network 82. The training data, which is used in the machine learning for the neural network 82, is labeled data. The labeled data is, for example, data in which a training image (for example, the captured image 73) and correct answer data are associated with each other. The correct answer data is data predetermined as ideal data output from the neural network 82. The correct answer data includes, for example, data in which a type of a subject (hereinafter, also referred to as a “subject class” or a “class”), which is included as a subject image in the training image, is specifiable. The subject refers to all subjects defined as the detection targets (for example, a person's face, the entire person, an animal other than a person, an airplane, a train, an insect, a building, a natural object, or the like).

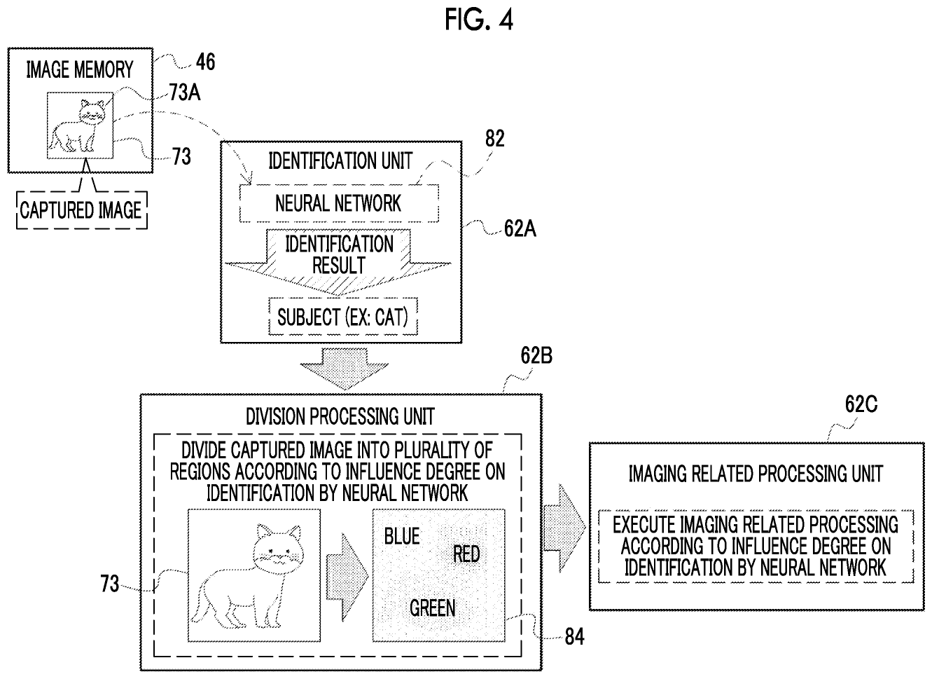

As an example shown in FIG. 4, the identification unit 62A acquires the captured image 73 from the image memory 46. In the example shown in FIG. 4, the captured image 73 includes a cat image 73A showing a cat. That is, the captured image 73 includes a cat, which is a subject, as an image (in the example shown in FIG. 4, the cat image 73A). The cat is an example of a “subject” and a “target subject” according to the present disclosed technology. In the following description, the subject included in the image means a subject included as an image in the image. Further, the subject, which is present in the image, means a subject that is present as an image in the image.

The identification unit 62A causes the neural network 82 to identify the subject included in the captured image 73 by inputting the captured image 73, which is acquired from the image memory 46, to the neural network 82. Here, the identification of the subject means the identification of the class of the subject. That is, the neural network 82 identifies the class of the subject in a case where the captured image 73 is input. In the example shown in FIG. 4, the subject, which is included in the captured image 73, is identified as a “cat” by the neural network 82.

The division processing unit 62B performs the division processing. The division processing is processing of dividing the captured image 73 into a plurality of regions according to an influence degree (hereinafter, also simply referred to as an “influence degree”) on the identification of the subject with the neural network 82 performed with respect to the captured image 73. The plurality of regions are, for example, divided into pixel units according to the influence degree. The division processing unit 62B generates a CAM image 84 by performing the division processing. The CAM image 84 is an image showing a classification result in which a plurality of regions are classified according to the influence degree, and each pixel is colored according to the magnitude of the influence degree.

Here, although the magnitude of the influence degree is represented by color, this is only an example, and the magnitude of the influence degree may be represented by shade of a single color. Further, here, although the magnitude of the influence degree is distinguished for each pixel unit, this is only an example, and the magnitude of the influence degree may be distinguished for each pixel block unit consisting of a plurality of pixels.

The imaging-related processing unit 62C performs imaging-related processing (hereinafter, also referred to as “imaging-related processing”) according to the influence degree on the identification with the neural network 82 performed with respect to the captured image 73. For example, the imaging-related processing unit 62C performs the imaging-related processing based on the CAM image 84.

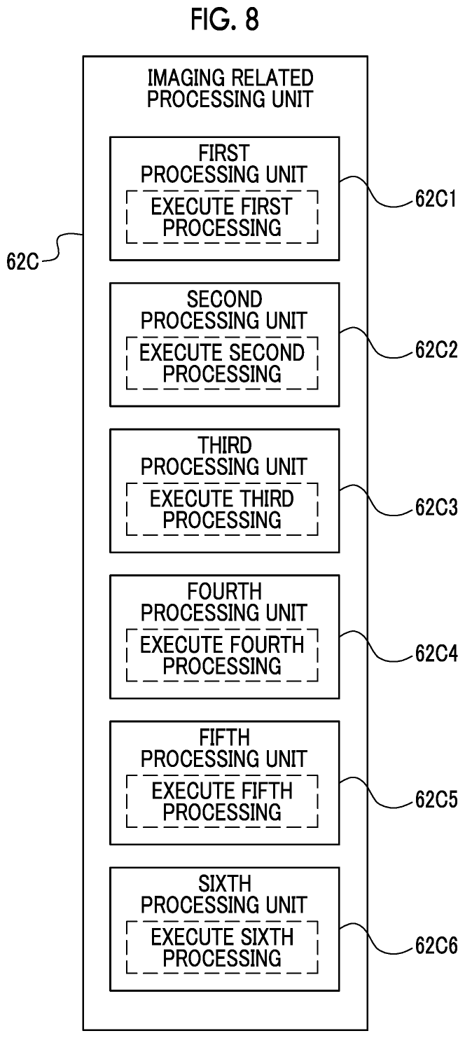

The imaging-related processing includes first processing, second processing, third processing, fourth processing, fifth processing, and sixth processing, which will be described later (see FIG. 8).

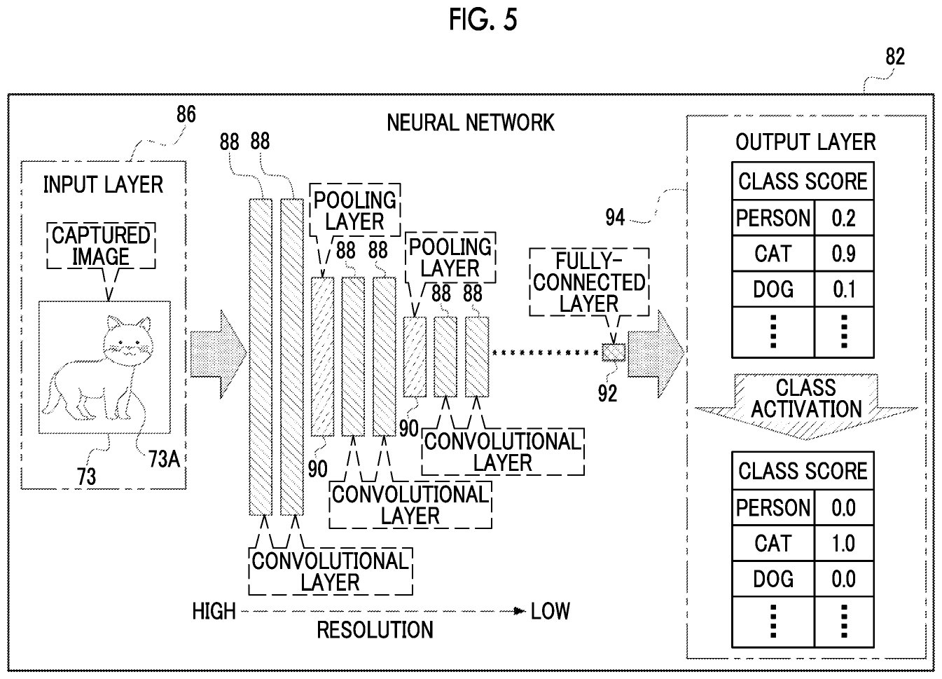

As an example shown in FIG. 5, the neural network 82 includes an input layer 86, a plurality of interlayers, and an output layer 94. In the example shown in FIG. 5, a plurality of convolutional layers 88, a plurality of pooling layers 90, and a fully-connected layer 92 are shown as an example of the plurality of interlayers. Here, the plurality of convolutional layers 88, the plurality of pooling layers 90, and the fully-connected layer 92 are examples of a “plurality of interlayers” according to the present disclosed technology. Here, although the plurality of interlayers are illustrated, the present disclosed technology is not limited to this, and a single interlayer may be used.

The captured image 73 is input to the input layer 86. In the example shown in FIG. 5, a captured image 73 including a cat as a subject is shown. The plurality of interlayers of the neural network 82 perform convolution processing, pooling processing, and full connection processing on the captured image 73 that is input to the input layer 86.

The convolutional layer 88 performs the convolution processing. The convolution processing is processing in which data related to the captured image 73 (for example, a feature map or the like) is provided from a layer in the previous stage, the feature data is condensed by performing filter processing on the data related to the captured image 73, and the condensed feature data is output to the next stage. The types of filters (for example, filters having 3×3 pixels) used among the plurality of convolutional layers 88 are different. For a plurality of channels (for example, channels such as red (R), green (G), and blue (B)), the plurality of convolutional layers 88 condense the feature data by performing the filter processing, which uses a filter defined for each channel, and generate and output a feature map in which the feature data is condensed.

The pooling layer 90 performs the pooling processing. The pooling processing is processing of reducing the feature map obtained by the convolutional layer 88 and outputting the reduced feature map to the next stage. Here, the reduction refers to a process of reducing an amount of data while leaving important data (for example, the maximum value of 2×2 pixels). That is, the pooling layer 90 reduces the feature map such that the resolution gradually decreases from the input layer 86 side to the output layer 94 side of the neural network 82.

The plurality of convolutional layers 88 and the pooling layers 90 are alternately disposed from the input side to the output side of the neural network 82, and the convolution processing and the pooling processing are alternately performed.

The fully-connected layer 92 performs the full connection processing. The full connection processing is processing of performing a convolution operation (for example, weighted averaging) that uses a unique weight for each feature map on all nodes in the next stage (for example, the output layer 94), with respect to the plurality of feature maps finally obtained for the plurality of channels. An example of all the nodes in the next stage includes a plurality of nodes corresponding to a plurality of classes.

The output layer 94 calculates a class score for the plurality of classes by using an activation function (for example, a softmax function). Thereafter, the output layer 94 performs class activation for the plurality of classes. The class activation refers to a process of converting a class score represented by a fraction into “0.0” or “1.0” based on a threshold value (for example, 0.8). In the example shown in FIG. 5, the class score of the cat is converted from “0.9” to “1.0”, and the class score of subjects other than the cat, that is, the class score lower than the threshold value is converted to “0.0”.

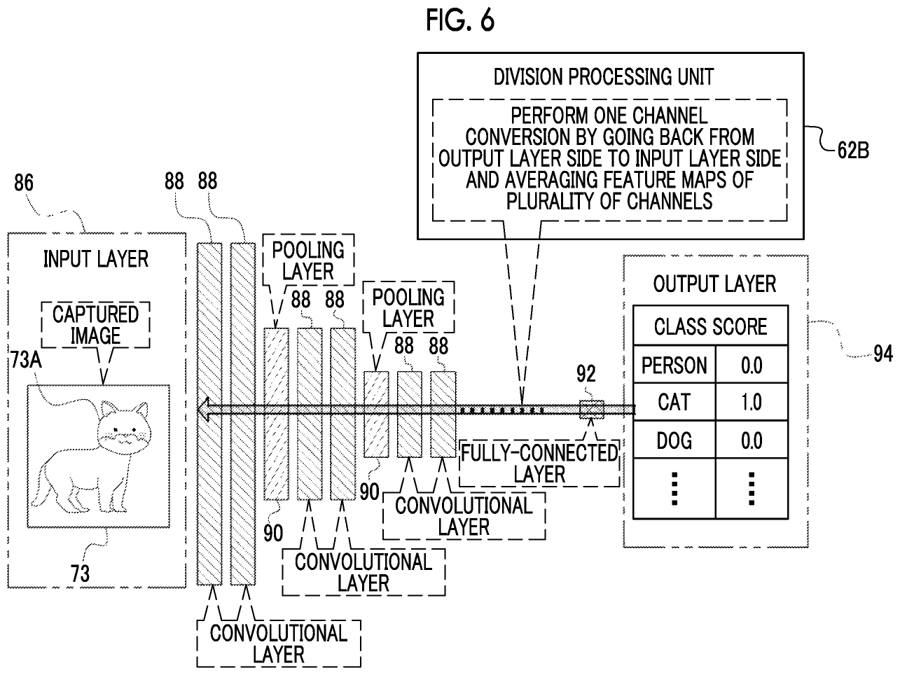

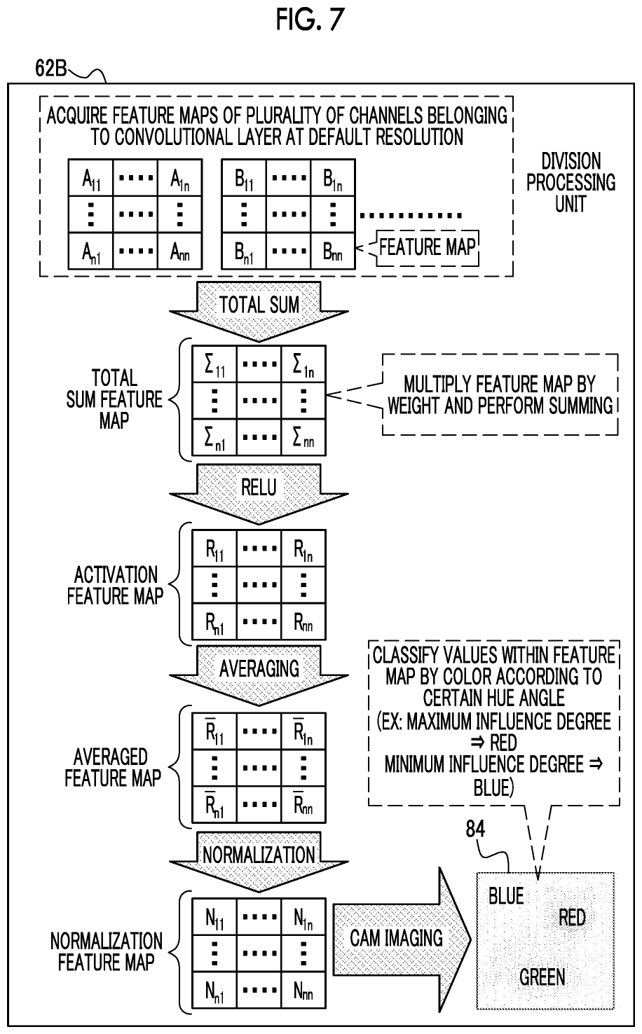

As an example shown in FIG. 6, the division processing unit 62B generates the CAM image 84 by performing a back propagation calculation. That is, the division processing unit 62B generates the CAM image 84 (see FIGS. 4 and 7) by performing one channel conversion by going back from the output layer 94 side to the input layer 86 side and averaging the feature maps of the plurality of channels. Regarding which layer of the plurality of interlayers to trace, it may be determined according to an instruction received by the reception device 76 (see FIG. 2), various conditions (for example, tint of the subject, texture of the subject, overall characteristics of the subject, a type of the subject, and/or an imaging condition), and/or the like.

Here, the method of generating the CAM image 84 will be specifically described. As an example shown in FIG. 7, first, the division processing unit 62B acquires the feature maps of the plurality of channels belonging to the convolutional layer 88 at a default resolution (for example, 200×200 pixels). The convolutional layer 88 having the default resolution is a convolutional layer 88 selected from among the plurality of interlayers. The convolutional layer 88 having the default resolution is selected by the division processing unit 62B according to, for example, the instruction received by the reception device 76 (see FIG. 2), various conditions (for example, an imaging condition), and/or the like.

Next, the division processing unit 62B calculates a total sum feature map showing a total sum of the feature maps of the plurality of channels. Here, the total sum refers to a value obtained by multiplying the feature map by a weight and performing summing. The weight to be multiplied with respect to the feature map is a value (“0.0” or “1.0”) for each class obtained by performing class activation in the output layer 94.

Next, the division processing unit 62B generates the activation feature map by activating the total sum feature map. For example, the activation feature map is obtained by activating a value of each pixel in the total sum feature map with RELU, which is an activation function, with respect to the total sum feature map. Here, although the RELU is illustrated, this is only an example, and instead of the RELU, an activation function that achieves the same or similar effect as RELU can be also applied.

Next, the division processing unit 62B generates an averaged feature map by averaging the values of each pixel in the activation feature map. Here, the averaging refers to dividing the values of each pixel in the activation feature map by the number of the plurality of channels.

The division processing unit 62B normalizes the values of each pixel in the averaged feature map to values within a range from 0.0 to 1.0 and generates the CAM image 84 by classifying the values assigned to each pixel by color according to a certain hue angle. Here, the value, which is assigned to each pixel, is a value derived based on the output of the interlayer (here, as an example, the convolutional layer 88 selected from among the plurality of interlayers) of the neural network 82 and indicates the influence degree on the identification with the neural network 82 (see FIGS. 4 to 6).

The influence degree on the identification with the neural network 82 is represented in pixel units with the CAM image 84. That is, in the CAM image 84, for example, within a certain hue angle from blue to red, each pixel is colored in a color that is determined according to the influence degree on the identification with the neural network 82. For example, in the CAM image 84 shown in FIG. 7, a color that indicates the maximum value of the influence degree is red, a color that indicates the minimum value of the influence degree is blue, and a color that indicates a middle value between the maximum value and the minimum value of the influence degree is green. Further, although three colors of red, green, and blue are illustrated here, each pixel in the actual CAM image 84 is classified with a plurality of colors (for example, all colors contained between a certain hue angle from blue to red) that are more than three colors.

Here, although an example of the embodiment in which the influence degree is derived based on the output of the convolutional layer 88 has been described, the present disclosed technology is not limited to this, and the influence degree may be derived based on the output of the pooling layer 90 (see FIGS. 5 and 6).

As an example shown in FIG. 8, the imaging-related processing unit 62C includes a first processing unit 62C1, a second processing unit 62C2, a third processing unit 62C3, a fourth processing unit 62C4, a fifth processing unit 62C5, and a sixth processing unit 62C6. The first processing unit 62C1 performs the first processing. The second processing unit 62C2 performs the second processing. The third processing unit 62C3 performs the third processing. The fourth processing unit 62C4 performs the fourth processing. The fifth processing unit 62C5 performs the fifth processing. The sixth processing unit 62C6 performs the sixth processing.

Here, the imaging-related processing unit 62C may perform two or more of the first to sixth processings in parallel and may selectively perform the first to sixth processings. Whether two or more processing are performed in parallel, or whether the first to sixth processings are selectively performed may be determined according to an instruction that is received by the reception device 76 or may be determined according to various conditions (for example, an imaging condition, or the like). Further, which of the first to sixth processings is to be performed may be determined according to an instruction that is received by the reception device 76 or may be determined according to various conditions (for example, an imaging condition, or the like).

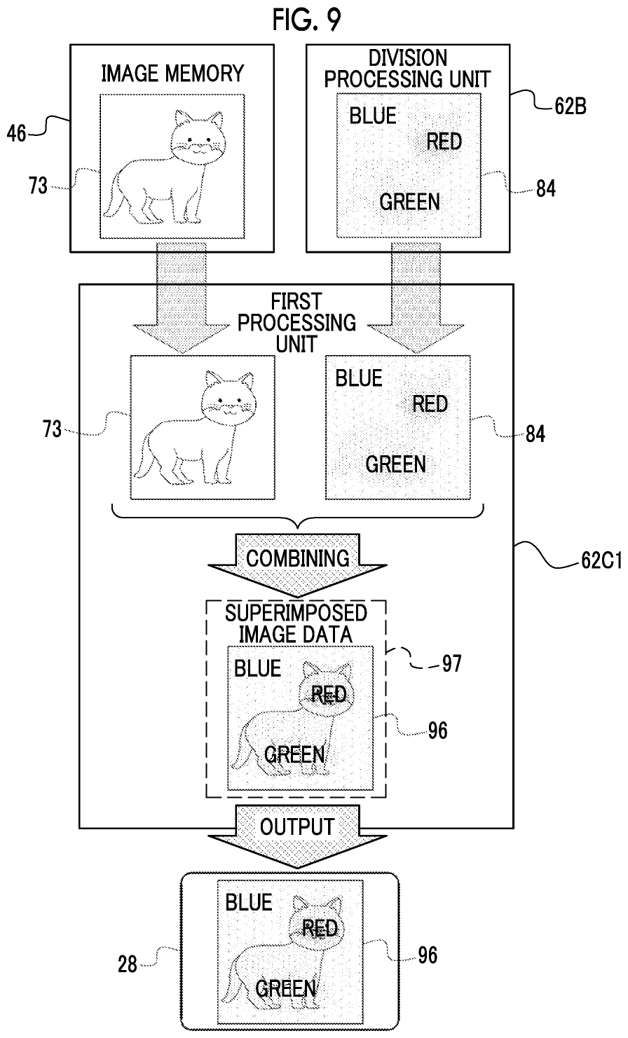

The first processing is processing of outputting first data for displaying the plurality of regions, which are obtained by dividing the captured image 73 through the division processing unit 62B, on the display 28 (see FIG. 9) in different manners according to the influence degree. Further, the first data is data for displaying the captured image 73 on the display 28 and data for displaying the plurality of regions, which are obtained by dividing the captured image 73 through the division processing unit 62B, in a state of being combined with the captured image 73 in different manners according to the influence degree.

The second processing is processing for a first region corresponding to a region, among the plurality of regions obtained by dividing the captured image 73 through the division processing unit 62B, having the influence degree equal to or higher than a first threshold value.

The third processing is processing of using data, as a reference, related to a region, among the plurality of regions obtained by dividing the captured image 73 through the division processing unit 62B, having the influence degree equal to or higher than a second threshold value.

In the imaging apparatus 12, the detection processing and the tracking processing are performed by the processor 62 on the premise that the fourth processing is performed. The detection processing is processing of detecting the target subject based on the captured image 73, and the tracking processing is processing of tracking the target subject based on the captured image 73. The fourth processing is processing of performing the tracking processing based on the CAM image 84 in a case where detection of the target subject with the detection processing is interrupted.

In the imaging apparatus 12, the detection processing and the tracking processing are selectively performed by the processor 62 on the premise that the fifth processing is performed. The fifth processing is processing of switching from the detection processing to the tracking processing in a case where the influence degree is equal to or higher than a third threshold value. For example, the fifth processing is processing of switching from the detection processing to the tracking processing based on a distribution state in which the influence degree in the captured image 73 is equal to or higher than the third threshold value.

The sixth processing is processing of outputting second data for displaying a first composite image and a second composite image on the display 28. The first composite image is an image obtained by combining the captured image 73 and detection target region specification information. The detection target region specification information refers to information in which a detection target region is specifiable. The detection target region refers to a region where a detection target is specifiable using the detection processing. The second composite image is an image obtained by combining the captured image 73 and tracking target region specification information. The tracking target region specification information refers to information in which a tracking target region is specifiable. The tracking target region refers to a region where a tracking target is specifiable using the tracking processing. The tracking target region is a region narrower than the detection target region.

Hereinafter, an example of the first to sixth processings will be described in more detail.

As an example shown in FIG. 9, the first processing unit 62C1 acquires the captured image 73 from the image memory 46 and acquires the CAM image 84 from the division processing unit 62B. The first processing unit 62C1 generates a superimposed image 96 by superimposing the CAM image 84 on the captured image 73. An example of a method of superimposing the CAM image 84 on the captured image 73 includes alpha blending. In this case, the transparency of the CAM image 84 is adjusted by changing an alpha value. The first processing unit 62C1 outputs superimposed image data 97 including the generated superimposed image 96 to the display 28. The superimposed image data 97 includes metadata and the like in addition to the superimposed image 96. The superimposed image 96, which is included in the superimposed image data 97, is displayed on the display 28. Here, the superimposed image data 97 is an example of “first data” according to the present disclosed technology.

Here, although an example of the embodiment in which the superimposed image 96 is displayed on the display 28 has been described, the present disclosed technology is not limited to this, and only the CAM image 84 may be displayed. Further, the captured image 73 and the CAM image 84 may be selectively displayed on the display 28. Further, in this case, the captured image 73 and the CAM image 84 may be alternately displayed at a frame rate (for example, a frame rate of 30 fps or higher) such that the independent display of the captured image 73 and the CAM image 84 cannot be visually perceived.

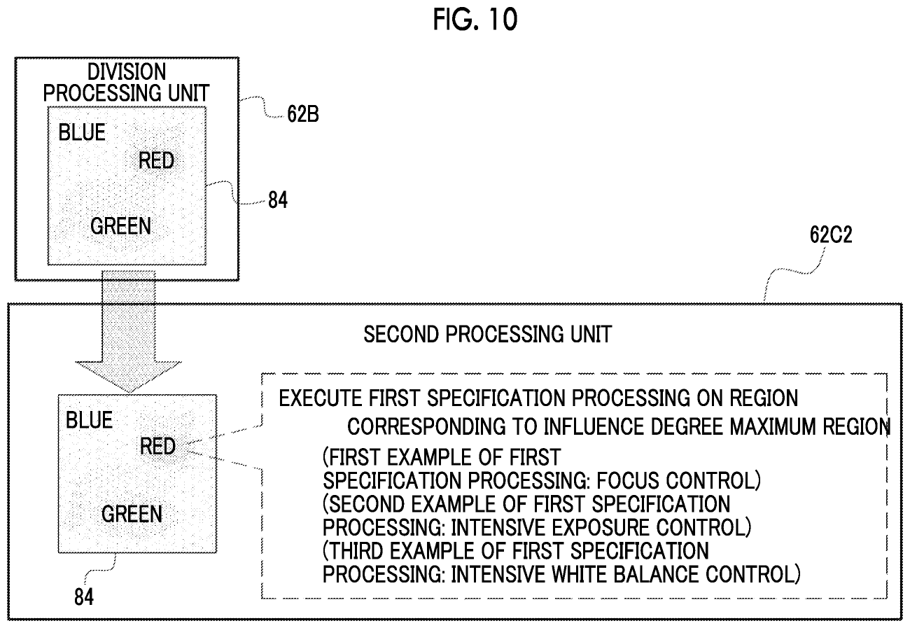

As an example shown in FIG. 10, the second processing unit 62C2 acquires the CAM image 84 from the division processing unit 62B and performs first specification processing on a region corresponding to the region where the influence degree is the maximum value (a “red” region in the example shown in FIG. 10). Here, the region corresponding to the region where the influence degree is the maximum value is an example of a “first region” according to the present disclosed technology.

A first example of the first specification processing includes focus control. A second example of the first specification processing includes intensive exposure control. A third example of the first specification processing includes intensive white balance control.

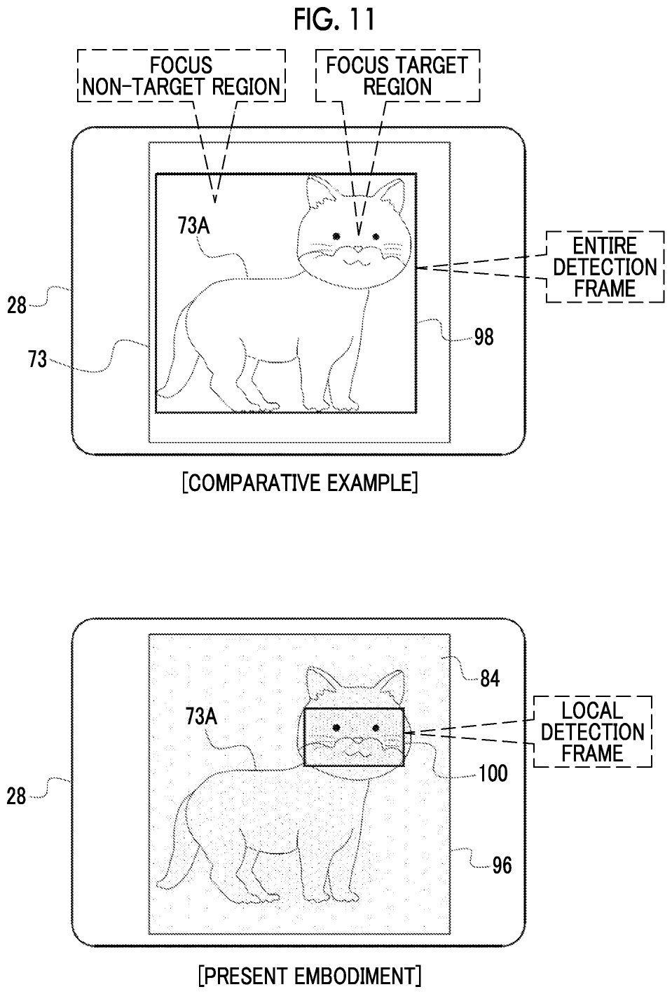

As an example shown in FIG. 11, in a detection method of the subject by using the known AI method in the related art, a bounding box itself (in the example shown in FIG. 11, a bounding box surrounding the cat image 73A included in the captured image 73), which is used for detection of the subject, is used as an entire detection frame 98. Therefore, the focus control, the exposure control, and the white balance control are performed on the region corresponding to the entire detection frame 98. In this case, for example, in the focus control, not only the calculation of a focus evaluation value (for example, a contrast value and/or a parallax, or the like) is performed on the cat image 73A, which is an ideal region as the focus target region but also the calculation of the focus evaluation value is performed even for the focus non-target region, which is a region other than the cat image 73A in the entire detection frame 98. In a case where the exposure control and the white balance control are also performed, the calculation is performed on the region other than the cat image 73A in the entire detection frame 98.

In contrast to this, the second processing unit 62C2 according to the present embodiment generates a local detection frame 100 that surrounds only the region in the CAM image 84 where the influence degree is the maximum value, and displays the local detection frame 100 on the display 28. In the example shown in FIG. 11, the local detection frame 100 is superimposed and displayed on the superimposed image 96. The second processing unit 62C2 performs the focus control, the exposure control, and the white balance control on the region surrounded by the local detection frame 100. Accordingly, the focus control, the exposure control, and the white balance control are performed on the region where the influence degree on the identification with the neural network 82 is highest.

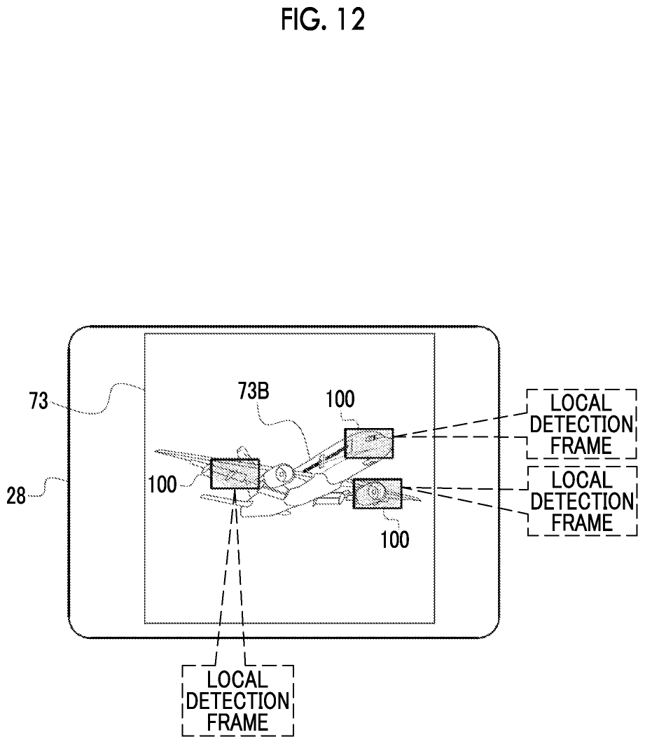

In the example shown in FIG. 11, although an example of the embodiment in which one local detection frame 100 is used has been described, the present disclosed technology is not limited to this, and as an example shown in FIG. 12, a plurality of local detection frames 100 may be used. In the example shown in FIG. 12, the captured image 73 includes an airplane image 73B showing an airplane, and three locations of regions in the CAM image 84 where the influence degree is the maximum value are present. In this case, the second processing unit 62C2 sets the local detection frame 100 with respect to each of the regions in the CAM image 84 where the influence degree is the maximum value and performs the focus control, the exposure control, and the white balance control. In a case where the focus control is performed by the second processing unit 62C2, one of the plurality of local detection frames 100 is selected according to any method (for example, an instruction received by the reception device 76), and the focus control may be performed on the region corresponding to the selected local detection frame 100. The same may be performed for the exposure control and/or the white balance control.

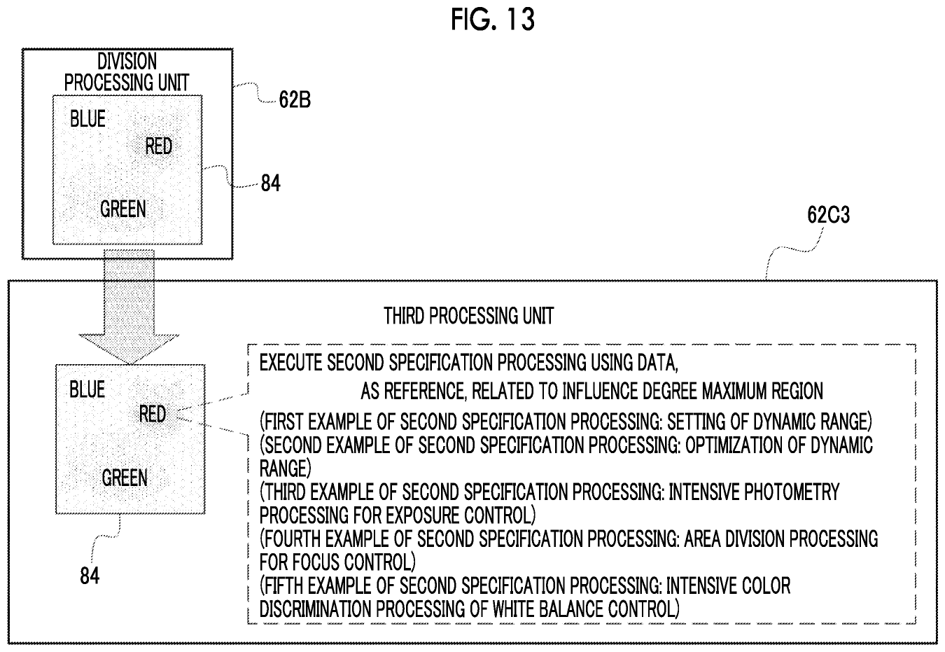

As an example shown in FIG. 13, the third processing unit 62C3 acquires the CAM image 84 from the division processing unit 62B and performs second specification processing of using data, as a reference, related to the region in the CAM image 84 (a “red” region in the example shown in FIG. 13) where the influence degree is the maximum value. The region corresponding to the region where the influence degree is the maximum value is an example of a “region where an influence degree is equal to or higher than a second threshold value” according to the present disclosed technology.

Here, a first example of the second specification processing includes setting of a dynamic range. A second example of the second specification processing includes optimization of the dynamic range. A third example of the second specification processing includes intensive photometry processing for exposure control. A fourth example of the second specification processing includes an area division processing for focus control. As a fifth example of the second specification processing, intensive color discrimination processing of the white balance control is performed.

Here, setting the dynamic range refers to, for example, setting to increase the dynamic range based on an integrated value of the brightness of an image region corresponding to the region in the captured image 73 where the influence degree is the maximum value and an integrated value of the brightness of other image regions. In this case, the integrated value of the brightness of the image region corresponding to the region in the captured image 73 where the influence degree is the maximum value is an example of “data related to a region where an influence degree is equal to or higher than a second threshold value” according to the present disclosed technology.

Further, the optimization of the dynamic range refers to, for example, setting of the dynamic range that uses, as a reference, the brightness of the image region corresponding to the region in the captured image 73 where the influence degree is the maximum value. In this case, the brightness of the image region corresponding to the region in the captured image 73 where the influence degree is the maximum value is an example of “data related to a region where an influence degree is equal to or higher than a second threshold value” according to the present disclosed technology.

Further, the intensive photometry processing for exposure control refers to, for example, processing in which photometry for exposure control with respect to the image region, which corresponds to the region in the captured image 73 where the influence degree is the maximum value, is performed more intensively than photometry for exposure control with respect to other image regions. In this case, the image region corresponding to the region in the captured image 73 where the influence degree is the maximum value is an example of “data related to a region where an influence degree is equal to or higher than a second threshold value” according to the present disclosed technology.

Further, the area division processing for focus control refers, for example, processing of dividing the image region, which corresponds to the region in the captured image 73 where the influence degree is the maximum value, as a plurality of areas used for focus control. In this case, the image region corresponding to the region in the captured image 73 where the influence degree is the maximum value is an example of “data related to a region where an influence degree is equal to or higher than a second threshold value” according to the present disclosed technology.

Further, in the intensive color discrimination processing of the white balance control refers to, for example, processing of discriminating color to be applied in the white balance control using the image region, which corresponds to the region in the captured image 73 where the influence degree is the maximum value, as a target. In this case, the image region corresponding to the region in the captured image 73 where the influence degree is the maximum value is an example of “data related to a region where an influence degree is equal to or higher than a second threshold value” according to the present disclosed technology.

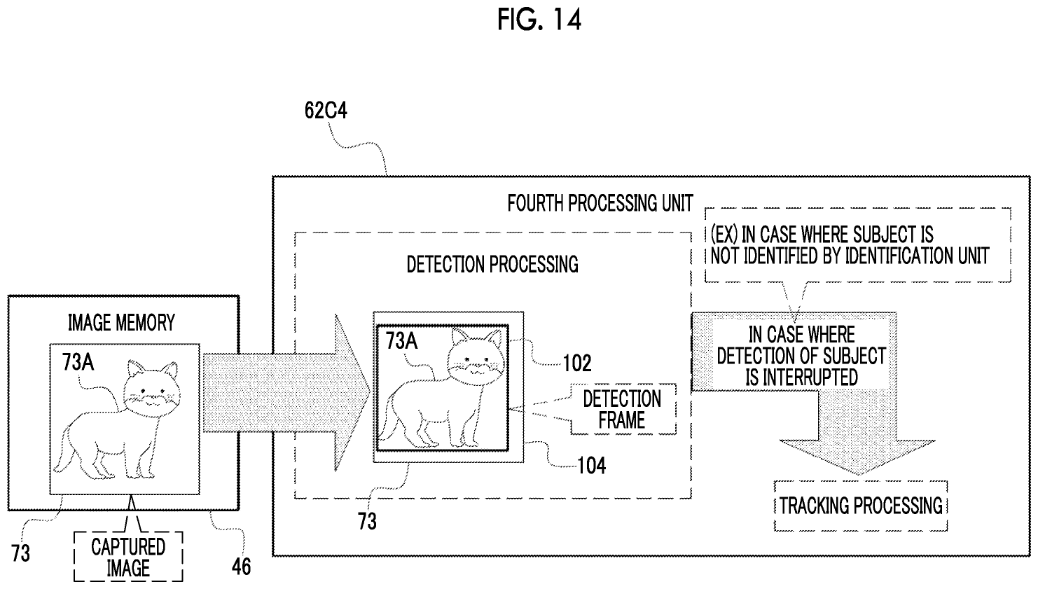

As an example shown in FIG. 14, the fourth processing unit 62C4 performs the detection processing and the tracking processing. In the detection processing, the detection of the subject is performed by using the AI method. For example, the detection of the subject by using the AI method is realized by the identification unit 62A performing the identification of the subject using the neural network 82. A bounding box is used in the detection of the subject (for example, a cat) by using the AI method. The fourth processing unit 62C4 generates a bounding box (in the example shown in FIG. 14, a bounding box surrounding the entire cat image 73A) used in the detection of the subject by using the AI method as a detection frame 102. The detection frame 102 is a frame in which the detection target region is specifiable using the detection processing. The fourth processing unit 62C4 generates a superimposed image 104 by superimposing the detection frame 102 on the captured image 73.

An example of the captured image 73, on which the detection frame 102 is superimposed, includes a live view image 108 (see FIG. 16). The captured image 73 is not limited to the live view image 108, and a post view image may be used. Further, the captured image 73 on which the detection frame 102 is superimposed is not limited to a moving image and may be a still image. The detection frame 102 is an example of “detection target region specification information” and a “first frame” according to the present disclosed technology.

By the way, in a case where a relative positional relationship between the subject (for example, a cat) and the imaging apparatus 12 is changed, or in a case where a zoom magnification is changed while the detection processing is being performed, it is conceivable that the detection of the subject using the detection processing is interrupted. Here, the interruption of the detection of the subject using the detection processing means, for example, that the subject has not been identified (for example, all class scores of each class after class activation are “0.0”) by the identification unit 62A. An example of the cause in which the subject is not identified by the identification unit 62A includes insufficient training with respect to the neural network 82.

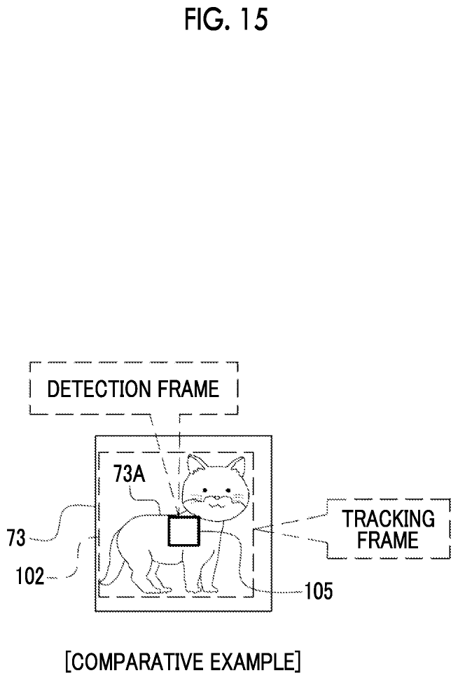

Therefore, the fourth processing unit 62C4 performs the tracking processing in a case where the detection of the subject (the cat in the example shown in FIG. 14) using the detection processing is interrupted. Here, as an example shown in FIG. 15, a tracking frame 105 is used in the known tracking processing in the related art. The tracking frame 105 is a frame in which the tracking target region is specifiable using the tracking processing.

The tracking frame 105 is smaller than the detection frame 102. That is, the tracking target region is narrower than the detection target region. Generally, the size of the tracking frame 105 is substantially 10% to 20% of the size of the detection frame 102.

Further, as general technology, there is known technology of disposing the tracking frame 105 at a predetermined location (for example, a central portion) in the captured image 73 at a time at which the tracking processing is started. In this case, in a case where the image region, which shows a characteristic portion of the cat (for example, face), is positioned at the predetermined location in the captured image 73, the tracking processing can be started smoothly, but in a case where the image region, which shows a portion other than the characteristic portion of the cat (for example, body) in the cat image 73A, is positioned at the predetermined location in the captured image 73, the tracking frame 105 may be disposed on the image region, which shows the portion other than the characteristic portion of the cat.

In a state in which the tracking frame 105 is disposed on the image region, which shows the portion other than the characteristic portion of the cat, it is difficult to smoothly start the tracking processing as compared with a state in which the tracking frame 105 is disposed in the image region, which shows the characteristic portion of the cat.

Therefore, as an example shown in FIG. 16, the fourth processing unit 62C4 performs the tracking processing based on the CAM image 84 in a case where the detection of the subject using the detection processing is interrupted. The fourth processing unit 62C4 generates the tracking frame 105 at a position where the center of the tracking frame 105 coincides with the center of the region in the CAM image 84 where the influence degree is the maximum value. Thereafter, the fourth processing unit 62C4 superimposes the tracking frame 105 on the first frame of the live view image 108 as the captured image 73. A position where the live view image 108 is superimposed on the first frame is a position corresponding to the region in the CAM image 84 where the influence degree is the maximum value.

The fourth processing unit 62C4 starts the tracking processing of the subject on the live view image 108 by using the template matching using the tracking frame 105. That is, the fourth processing unit 62C4 generates a template (in the example shown in FIG. 16, the image showing the face in the cat image 73A) by cutting out a region surrounded by the tracking frame 105 for the first frame of the live view image 108 and tracks the subject by performing the template matching using the template for the second and subsequent frames of the live view image 108. Here, the tracking frame 105 is an example of “tracking target region specification information” and a “second frame” according to the present disclosed technology.

By the way, it is generally known that the larger the tracking target region is, the larger the operational load of the tracking processing is. Therefore, in the fifth processing, the detection processing is switched to the tracking processing according to a scale in which the influence degrees, which are equal to or higher than a default value, are distributed in the CAM image 84. That is, in the fifth processing, the detection processing is switched to the tracking processing in a case where a scale in which the influence degrees, which are equal to or higher than a default value, are distributed in the CAM image 84 is less than a certain scale.

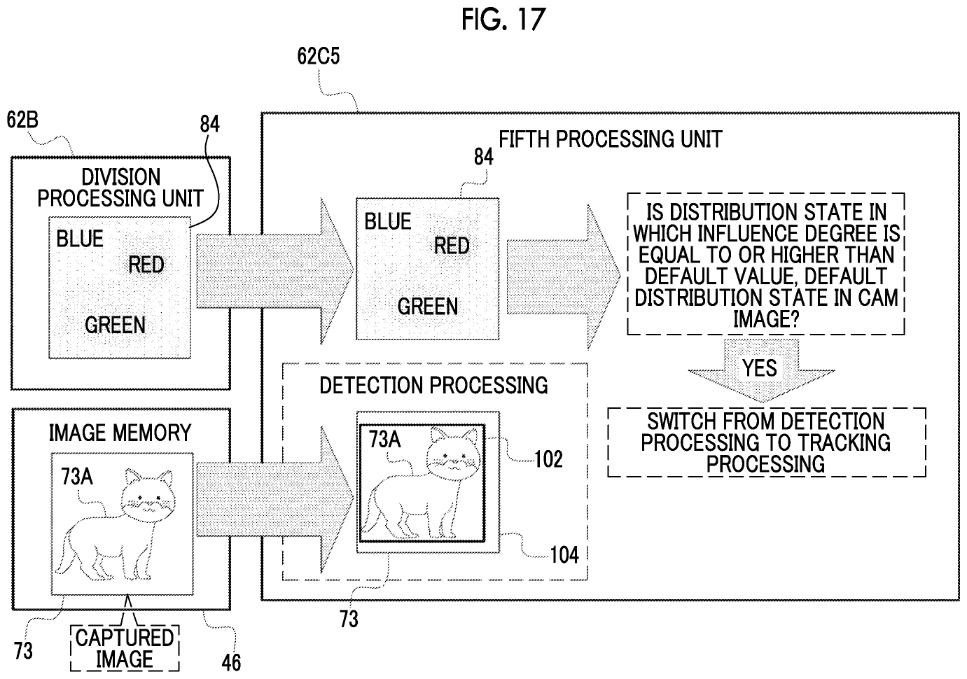

In this case, for example, as shown in FIG. 17, the fifth processing unit 62C5 acquires the CAM image 84 from the division processing unit 62B in a state where the detection processing is being performed. In the CAM image 84, the fifth processing unit 62C5 determines whether or not a distribution state in which the influence degree is equal to or higher than the default value, is a default distribution state. Here, the default value is an example of a “third threshold value” according to the present disclosed technology.

The distribution state in which the influence degree is equal to or higher than the default value is specified, for example, by a product of the maximum value of the influence degree and a total number of pixels in which the influence degree is the maximum value (hereinafter, also referred to as “maximum number of pixels of influence degree”). In this case, whether or not the distribution state in which the influence degree is equal to or higher than the default value is the default distribution state is determined by whether or not the product of the maximum value of the influence degree and the maximum number of pixels of influence degree is equal to or less than a reference value. The reference value (for example, a value to be compared with the product of the maximum value of the influence degree and the maximum number of pixels of influence degree) may be a fixed value and may be an instruction, which is received by the reception device 76, or a variable value, which is changed according to various conditions (for example, an imaging condition). Further, although the maximum value of the influence degree is illustrated here, this is only an example, and instead of the maximum value of the influence degree, a value that is smaller than the maximum value of the influence degree (for example, a median value, an average value, or the like) may be applied. Further, although the maximum number of pixels of influence degree is illustrated here, this is only an example, and instead of the maximum number of pixels of influence degree, an area of the region where the pixels in which the influence degree is the maximum value are grouped may be applied.

In the CAM image 84, the fifth processing unit 62C5 switches from the detection processing to the tracking processing in a case where it is determined that the distribution state in which the influence degree is equal to or higher than the default value is the default distribution state.

Further, although an example of the embodiment in which the detection processing is switched to the tracking processing has been described here, the present disclosed technology is not limited to this. For example, the fifth processing unit 62C5 may determine whether or not the distribution state in which the influence degree is equal to or higher than the default value is the default distribution state, in a state where the tracking processing is being performed in the CAM image 84, and in a case where it is determined that the distribution state in which the influence degree is equal to or higher than the default value is not the default distribution state, the fifth processing unit 62C5 may switch from tracking processing to detection processing.

Further, although the fourth processing and the fifth processing are executed independently here, the present disclosed technology is not limited to this, and the fifth processing may be incorporated into the fourth processing. That is, in a case in which the detection of the subject using the detection processing is interrupted and the distribution state in which the influence degree is equal to or higher than the default value reaches the default distribution state, the detection processing may be switched to the tracking processing.

Further, although an example of the embodiment in which the detection processing is switched to the tracking processing in a case where the distribution state in which the influence degree is equal to or higher than the default value is the default distribution state has been described here, the present disclosed technology is not limited to this, and the detection processing may be switched to the tracking processing in a case where at least one pixel having the influence degree equal to or higher than the default value is present in the CAM image 84.

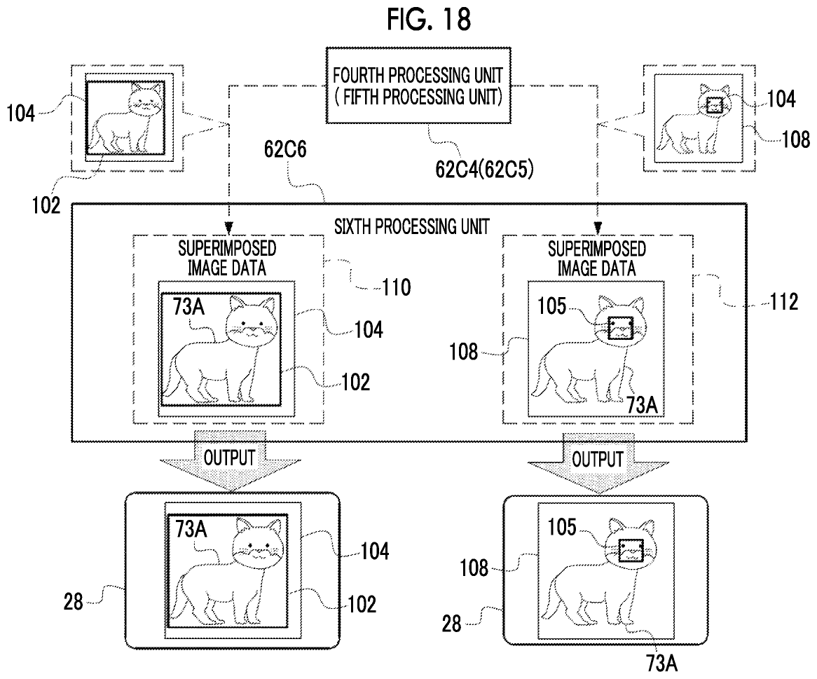

As an example shown in FIG. 18, the sixth processing unit 62C6 acquires the superimposed image 104 from the fourth processing unit 62C4 and generates superimposed image data 110 including the acquired superimposed image 104. The sixth processing unit 62C6 outputs the superimposed image data 110 to the display 28. The superimposed image data 110 includes metadata and the like in addition to the superimposed image 104. The superimposed image 104, which is included in the superimposed image data 110, is displayed on the display 28.

Further, the sixth processing unit 62C6 acquires the live view image 108 on which the tracking frame 105 is superimposed, from the fourth processing unit 62C4. The sixth processing unit 62C6 generates superimposed image data 112 including the live view image 108 on which the tracking frame 105 is superimposed. The superimposed image data 112 includes metadata and the like in addition to the live view image 108 on which the tracking frame 105 is superimposed. The display 28 displays the live view image 108 included in the superimposed image data 112, that is, the live view image 108 on which the tracking frame 105 is superimposed.

Here, the superimposed image 104 is an example of a “first composite image” according to the present disclosed technology. The live view image 108 on which the tracking frame 105 is superimposed is an example of a “second composite image” according to the present disclosed technology. The superimposed image data 110 is an example of “second data” according to the present disclosed technology. The superimposed image data 112 is an example of “second data” according to the present disclosed technology.

Next, an operation of the part of the imaging apparatus 12 according to the present disclosed technology will be described with reference to FIG. 19.

FIG. 19 shows an example of a flow of imaging support processing performed by the processor 62 of the imaging apparatus 12. The flow of the imaging support processing shown in FIG. 19 is an example of an “imaging support method” according to the present disclosed technology.

In the imaging support processing shown in FIG. 19, first, in step ST10, the identification unit 62A determines whether or not the captured image 73 is stored in the image memory 46. In step ST10, in a case where the captured image 73 is not stored in the image memory 46, the determination is set as negative, and the imaging support processing shifts to step ST20. In step ST10, in a case where the captured image 73 is stored in the image memory 46, the determination is set as positive, and the imaging support processing shifts to step ST12.

In step ST12, the identification unit 62A acquires the captured image 73 from the image memory 46. After the processing in step ST12 is executed, the imaging support processing shifts to step ST14.

In step ST14, the identification unit 62A causes the neural network 82 to identify the subject shown in the captured image 73 acquired in step ST12. After the processing in step ST14 is executed, the imaging support processing shifts to step ST16.

In step ST16, the division processing unit 62B generates the CAM image 84 by dividing the captured image 73 into a plurality of regions (for example, for each pixel) according to the influence degree on the identification of the subject with the neural network 82. After the processing in step ST16 is executed, the imaging support processing shifts to step ST18.

In step ST18, the imaging-related processing unit 62C performs imaging-related processing (for example, the first to sixth processings) based on the CAM image 84 generated in step ST16. That is, the imaging-related processing unit 62C performs the imaging-related processing according to the influence degree on the identification of the subject with the neural network 82. After the processing in step ST18 is executed, the imaging support processing shifts to step ST20.

In step ST20, the imaging-related processing unit 62C determines whether or not the condition for ending the imaging support processing (hereinafter, also referred to as an “imaging support processing end condition”) is satisfied. Examples of the imaging support processing end condition include a condition in which the imaging mode that is set for the imaging apparatus 12 is canceled, a condition in which an instruction to end the imaging support processing is received by a reception device 76, or the like. In step ST20, in a case where the imaging support processing end condition is not satisfied, the determination is set as negative, and the imaging support processing shifts to step ST10. In step ST20, in a case where the imaging support processing end condition is satisfied, the determination is set as positive, and the imaging support processing is ended.

As described above, in the imaging apparatus 12, the subject, which is included in the captured image 73, is identified by the neural network 82 by inputting the captured image 73 to the neural network 82. Thereafter, the imaging-related processing is performed according to the influence degree on the identification with the neural network 82 performed with respect to the captured image 73. Therefore, according to the present configuration, it is possible to contribute to realization of imaging suitable for the subject as compared with the case where the control related to the imaging is performed using only information irrelevant to the influence degree on the identification with the neural network 82 performed with respect to the captured image 73.

Further, in the imaging apparatus 12, the CAM image 84 is generated by dividing the captured image 73 into the plurality of regions according to the influence degree. Therefore, according to the present configuration, it is possible to selectively perform imaging-related processing on the plurality of regions according to the influence degree as compared with the case where the captured image 73 is not divided into the plurality of regions according to the influence degree.

Further, in the imaging apparatus 12, the plurality of regions, which are obtained by dividing the captured image 73 according to the influence degree, are displayed on the display 28 in different manners depending on the influence degree by being visualized as a CAM image 84. Therefore, according to the present configuration, it is possible for the user to visually recognize a difference, between the plurality of regions (for example, between the pixels), in the influence degrees on the identification of the subject with the neural network 82 performed on the captured image 73.

Further, in the imaging apparatus 12, the superimposed image 96, which is obtained by superimposing the CAM image 84 on the captured image 73, is displayed on the display 28. Therefore, according to the present configuration, it is possible for the user to visually recognize which region in the captured image 73 influences the identification of the subject with the neural network 82.

Further, in the imaging apparatus 12, the first specification processing (for example, the focus control, the intensive exposure control, the intensive white balance control, and/or the like) is performed on the region corresponding to the region, from among the plurality of regions included in the CAM image 84, where the influence degree is the maximum value. Therefore, according to the present configuration, it is possible to prevent the first specification processing from being performed on a region not intended by the user as compared with the case where the first specification processing is performed on the selected region irrelevant to the influence degree on the identification of the subject with the neural network 82.

Further, in the imaging apparatus 12, the second specification processing (for example, setting of the dynamic range, optimization of the dynamic range, intensive photometry processing for exposure control, area division processing for focus control, intensive color discrimination processing for white balance control, and/or the like) is performed using the data, which is related to the region in the CAM image 84 where the influence degree is the maximum value, as a reference. Therefore, according to the present configuration, it is possible to accurately perform the second specification processing on the region intended by the user as compared with the case where the second specification processing is performed using the data, which is related to the selected region irrelevant to the influence degree on the identification of the subject with the neural network 82, as a reference.

Further, in the imaging apparatus 12, the imaging-related processing is performed based on a result (for example, the CAM image 84) in which the plurality of regions (for example, all pixels) obtained by dividing the captured image 73 are classified according to the influence degree. Therefore, according to the present configuration, it is possible to contribute to the realization of the imaging suitable for the subject as compared with the case where imaging related control is performed using only information that is completely irrelevant to the result in which the plurality of regions obtained by dividing the captured image 73 are classified according to the influence degree.

Further, in the imaging apparatus 12, the tracking processing is performed based on a result (for example, the CAM image 84) in which the plurality of regions (for example, all pixels) obtained by dividing the captured image 73 are classified according to the influence degree in a case where the detection of the subject using the detection processing is interrupted. Therefore, according to the present configuration, it is possible to prevent the tracking processing from being started from a subject unintended by the user in a case where the detection of the subject through the detection processing is interrupted as compared to the case where the tracking processing is performed using only information completely irrelevant to the result in which the plurality of regions obtained by dividing the captured image 73 are classified according to the influence degree.

Further, in the imaging apparatus 12, the detection processing is switched to the tracking processing based on the distribution state in which the influence degree is equal to or higher than the default value. Therefore, according to the present configuration, it is possible to reduce the operational load on the processor 62 as compared with the case where the detection processing is always performed regardless of the distribution state in which the influence degree is equal to or higher than the default value. The detection processing may be switched to the tracking processing in a case where a pixel having the influence degree equal to or higher than the default value is present in the CAM image 84. In this case, it is possible to reduce the operational load on the processor 62 as compared with the case where the detection processing is always performed regardless of whether or not the pixel having the influence degree equal to or higher than the default value is present in the CAM image 84.

Further, in the imaging apparatus 12, the tracking target region where a tracking target is specifiable using the tracking processing is narrower than the detection target region where a detection target is specifiable using the detection processing. Therefore, according to the present configuration, it is possible to reduce the operational load required for the tracking processing more than the detection processing as compared with the case where a width of the tracking target region is equal to or larger than a width of the detection target region.

Further, in the imaging apparatus 12, the superimposed image 104, which is obtained by superimposing the detection frame 102 on the captured image 73, and the live view image 108 on which the tracking frame 105 is superimposed are displayed on the display 28. Therefore, according to the present configuration, it is possible for the user to visually recognize the detection target and the tracking target.

Further, in the imaging apparatus 12, the influence degree is derived based on an output of the interlayer of the neural network 82. Therefore, according to the present configuration, it is possible to obtain a highly accurate influence degree as compared with the case where the influence degree is derived using only a layer other than the interlayer in the neural network 82.

Further, in the imaging apparatus 12, the influence degree is derived based on the output of the interlayer selected from the plurality of interlayers of the neural network 82.

Therefore, according to the present configuration, it is possible to reduce the load required for deriving the influence degree as compared with the case where the influence degree is derived based on the outputs from all the interlayers.

### First Modification Example

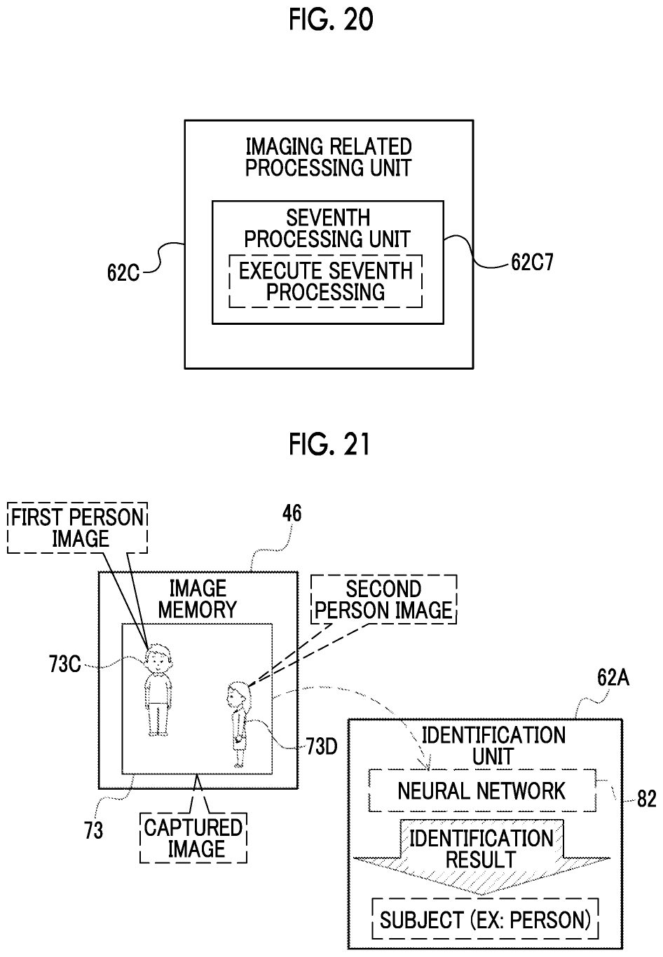

As an example shown in FIG. 20, the imaging-related processing unit 62C includes a seventh processing unit 62C7. The seventh processing unit 62C7 performs the seventh processing. The seventh processing is processing of selecting one subject from among the plurality of subjects based on at least one of the influence degree or the distribution state of the influence degrees in a case where the captured image 73 includes a plurality of subject images showing a plurality of subjects.

In this case, for example, as shown in FIG. 21, the captured image 73 includes a first person image 73C and a second person image 73D. The first person image 73C is an image obtained by imaging a first person from a front surface side, and the second person image 73D is an image obtained by imaging a second person from a side surface side. Here, the first person and the second person are examples of a “plurality of subjects” and “subjects of the same type” according to the present disclosed technology. Hereinafter, for convenience of explanation, in a case where it is not necessary to distinguish between the first person and the second person, the first person and the second person will be referred to as a “person”.

The identification unit 62A causes the neural network 82 to identify the person as the subject by inputting the captured image 73 including the first person image 73C and the second person image 73D to the neural network 82.

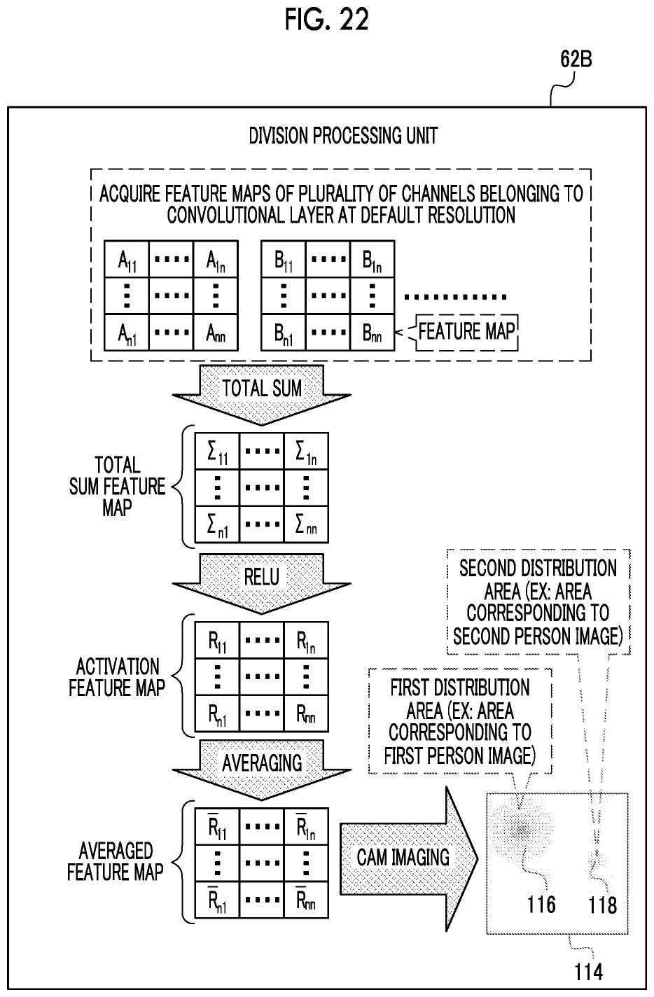

As an example shown in FIG. 22, the division processing unit 62B differs from the division processing unit 62B shown in FIG. 7 in that the averaged feature map is not normalized and in that a CAM image 114 is generated instead of the CAM image 84. The division processing unit 62B generates the CAM image 114 from the averaged feature map without normalizing the averaged feature map.

The CAM image 114 includes a first distribution area 116 and a second distribution area 118. The first distribution area 116 is an area corresponding to the first person image 73C, and the second distribution area 118 is an area corresponding to the second person image 73D. The first distribution area 116 and the second distribution area 118 are areas in which a plurality of pixels having the influence degree equal to or higher than a certain value are aggregated.

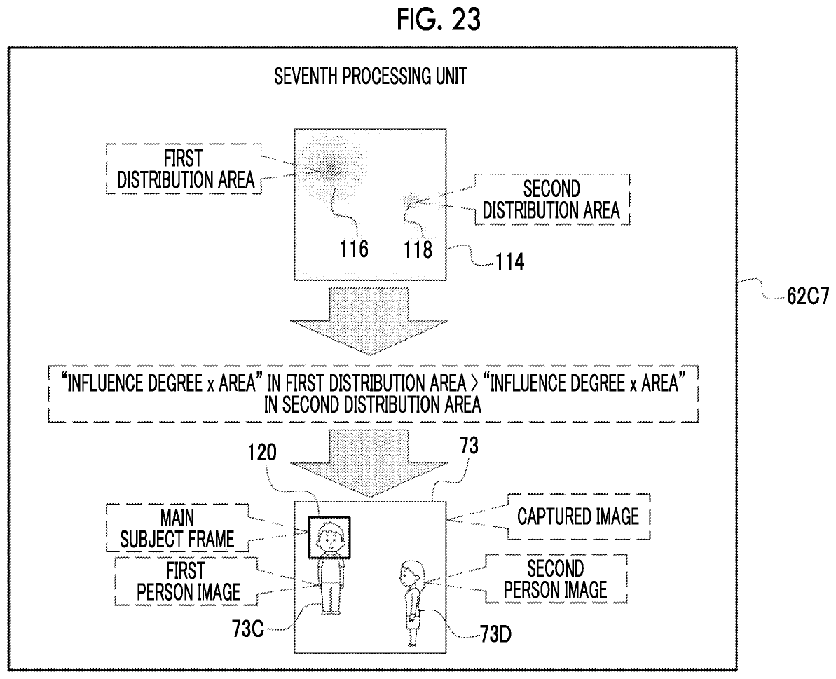

Therefore, as an example shown in FIG. 23, the seventh processing unit 62C7 calculates a product of the influence degree of the first distribution area 116 and an area of the first distribution area 116. The influence degree of the first distribution area 116 refers to, for example, an average value of influence degrees within an area where the influence degrees within a certain value from the centroid are distributed in a case where the pixel having the highest influence degree in the first distribution area 116 is used as the centroid. The area of the first distribution area 116 refers to, for example, an area of the region where the influence degrees within a certain value from the centroid are distributed in a case where the pixel having the highest influence degree in the first distribution area 116 is used as the centroid. Here, although the average value of the influence degrees in the area where the influence degree within a certain value from the centroid are distributed in a case where the pixel having the highest influence degree in the first distribution area 116 is used as the centroid has been described, this is only an example, and instead of the average value, the maximum value, a median value, a most frequent value, or the like may be applied.

The seventh processing unit 62C7 calculates the product of the influence degree of the second distribution area 118 and the area of the second distribution area 118. The influence degree of the second distribution area 118 refers to, for example, an average value of influence degrees within an area where the influence degrees within a certain value from the centroid are distributed in a case where the pixel having the highest influence degree in the second distribution area 118 is used as the centroid. The area of the second distribution area 118 refers to, for example, an area of the region where the influence degrees within a certain value from the centroid are distributed in a case where the pixel having the highest influence degree in the second distribution area 118 is used as the centroid. Here, although the average value of the influence degrees in the area where the influence degree within a certain value from the centroid is distributed in a case where the pixel having the highest influence degree in the second distribution area 118 is used as the centroid has been described, this is only an example, and instead of the average value, the maximum value, a median value, a mode value, or the like may be applied.

The seventh processing unit 62C7 compares the product of the influence degree of the first distribution area 116 and the area of the first distribution area 116 and the product of the influence degree of the second distribution area 118 and the area of the second distribution area 118, and selects either the first person or the second person as a main subject based on a comparison result. In the example shown in FIG. 23, since the product of the influence degree of the first distribution area 116 and the area of the first distribution area 116 is greater than the product of the influence degree of the second distribution area 118 and the area of the second distribution area 118, the first person shown in the first person image 73C corresponding to the first distribution area 116 is selected as the main subject. The seventh processing unit 62C7 sets a main subject frame 120 with respect to the first person image 73C showing the first person selected as the main subject. The main subject frame 120 is set, for example, with respect to the region of the first distribution area 116 where the highest influence degrees are distributed. In the example shown in FIG. 23, as an example of the main subject frame 120, a frame surrounding an image showing the face of the first person in the first person image 73C is shown.

As described above, in a case where the CAM image 114 is generated without normalizing the averaged feature map, a level of the influence degree is generated in a case where the captured image 73 includes a subject of the same type. Accordingly, the seventh processing unit 62C7 can distinguish between the main subject and the other subject by referring to the level of the influence degree. Therefore, according to the present configuration, even in a case where the captured image 73 includes a plurality of subjects, it is possible to make it easier for the user to select the intended subject as the main subject as compared with the case of selecting a subject, which is present at a fixed location in the captured image 73, as the main subject. Further, even in a case where the captured image 73 includes a plurality of subjects of the same type, it is possible to make it easier for the user to select the intended subject as the main subject as compared with the case of selecting a subject, which is present at a fixed location in the captured image 73, as the main subject. Further, it is possible to make it easier for the user to select the intended subject as compared with the case of selecting a subject, which is present in the captured image 73 other than the fixed location, as a subject other than the main subject.

Further, in a case where the subject is selected according to the level of the influence degree in this way, the focus control may be performed on the selected subject, or different weights may be assigned to the selected subject and other subjects, and the exposure control may be performed according to the weights. For example, the exposure control is performed in a state in which a weight of 0.7 is assigned to the first person and a weight of 0.3 is assigned to the second person such that the brightness for the first person and the brightness for the second person are aligned.

The seventh processing described in the present first modification example may be performed in parallel with one or more of the first to sixth processings described in the above-described embodiment, or may be performed independently of the first to sixth processings. Whether the seventh processing is to be performed in parallel with one or more of the first to sixth processings described in the above-described embodiment, or whether the seventh processing is to be performed independently of the first to sixth processings may be determined according to an instruction, which is received by the reception device 76, or may be determined according to various conditions (for example, an imaging condition, or the like). Further, which of the first to seventh processings is to be performed may be determined according to an instruction that is received by the reception device 76 or may be determined according to various conditions (for example, an imaging condition, or the like).

### Second Modification Example

In a case where the captured image 73 includes a plurality of types of subjects, and in a case where the division processing unit 62B collectively generates the activation feature map (see FIG. 22) for the plurality of types of subjects, confusion of information occurs between the plurality of classes, and for example, there is a risk that the maximum value of influence degree is assigned to an area where the subject is not present.

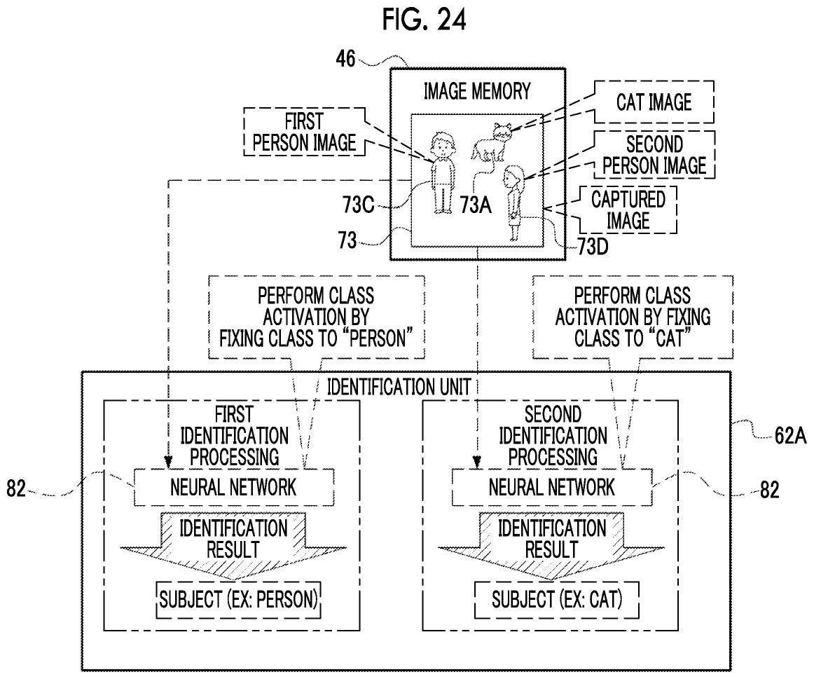

Therefore, the identification unit 62A causes the neural network 82 to identify a single subject class. For example, as shown in FIG. 24, in a case where the captured image 73 includes the cat image 73A, the first person image 73C, and the second person image 73D, the identification unit 62A executes processing, as the first identification processing, of causing the neural network 82 to perform class activation in a state in which the class is fixed to a “person” and executes processing, as the second identification processing, of causing the neural network 82 to perform the class activation in a state in which the class is fixed to a “cat”.

Accordingly, the activation feature map is generated for each class by the division processing unit 62B. That is, the generation of the activation feature map for a person and the generation of the activation feature map for a cat are performed independently.

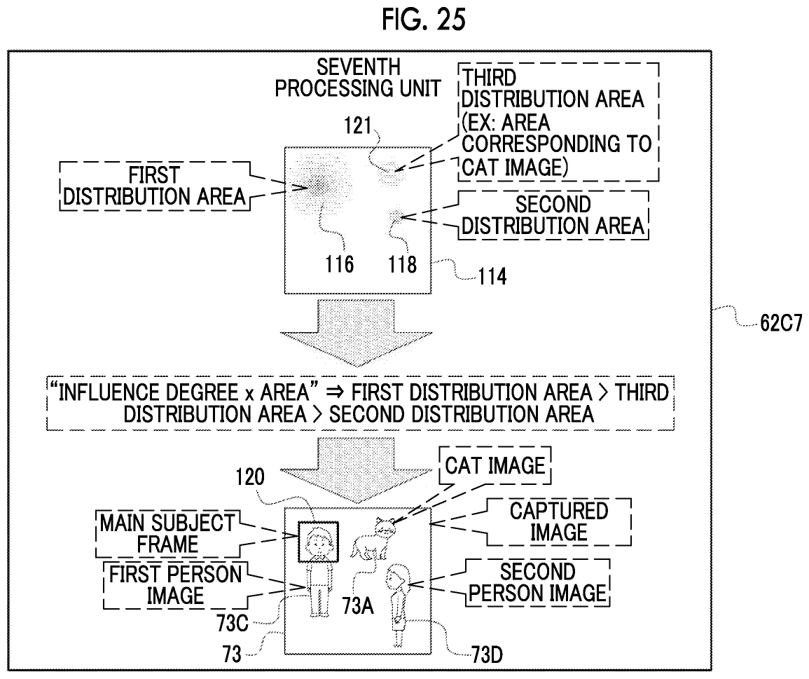

In this case, as an example shown in FIG. 25, the CAM image 114 represents a third distribution area 121 in addition to the first distribution area 116 and the second distribution area 118. The third distribution area 121 is an area corresponding to the cat image 73A. The seventh processing unit 62C7 also calculates the product of the influence degree and the area in the manner described in the first modification example, for the third distribution area 121. The seventh processing unit 62C7 compares the product of the influence degree and the area for the first distribution area 116, the product of the influence degree and the area for the second distribution area 118, and the product of the influence degree and the area for the third distribution area 121, and selects the main subject according to a comparison result.

Therefore, according to the present second modification example, even in a case where the captured image 73 includes the plurality of types of subjects, the CAM image 114 having a high reliability degree can be obtained as compared with the case where class activation is performed in the neural network 82 without fixing the class. As a result, it is possible to make it easier for the user to select the intended subject as the main subject as compared with the case where the class activation is performed in the neural network 82 without fixing the class.

### Third Modification Example

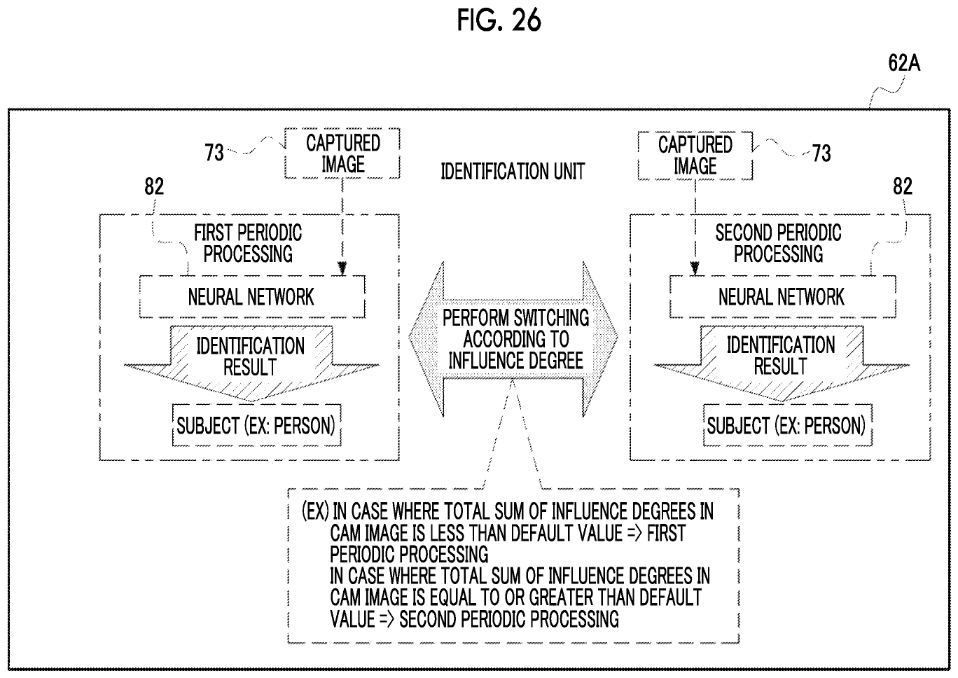

As an example shown in FIG. 26, the identification unit 62A performs first periodic processing and second periodic processing according to the influence degree. The first periodic processing is processing of causing the neural network 82 to identify the subject in a first period, and the second periodic processing is processing of causing the neural network 82 to identify the subject in a second period that is longer than the first period. The first periodic processing and the second periodic processing are switched according to the influence degree. For example, the first periodic processing is performed in a case where a total sum of the influence degrees in the CAM image 114 is less than a default value, and the second periodic processing is performed in a case where the total sum of the influence degrees in the CAM image 114 is equal to or greater than the default value. Further, in a case where the second periodic processing is performed, the tracking processing may be performed.

According to the present third modification example, the load on the calculation can be reduced as compared with the case where the neural network 82 always identifies the subject in the first period.

Although the detection frame 102 is shown in the above example, this is only an example, and for example, instead of the detection frame 102, a part of the detection frame 102 (for example, four corner portions of the detection frame 102) may be applied, or a region corresponding to the region surrounded by the detection frame 102 may be filled with a default translucent color (for example, translucent yellow). Further, instead of the detection frame 102, or together with the detection frame 102, characters and/or symbols that can specify that the region is the detection target region may be applied.

Although the tracking frame 105 is shown in the above example, this is only an example, and for example, instead of the tracking frame 105, a part of the tracking frame 105 (for example, four corner portions of the tracking frame 105) may be applied, or a region corresponding to the region surrounded by the tracking frame 105 may be filled with a default translucent color (for example, translucent blue). Further, instead of the tracking frame 105, or together with the tracking frame 105, characters and/or symbols that can specify that the region is the tracking target region may be applied.

In the above example, although an example of the embodiment in which the detection processing and the tracking processing are switched based on the CAM image 84 or 114 has been described, the present disclosed technology is not limited to this. For example, in addition to the CAM image 84 or 114, the detection processing and the tracking processing may be switched based on the class score, the object-ness score, which is the probability in which an object is present within the bounding box used in the detection of the subject by using the AI method, and/or the like.

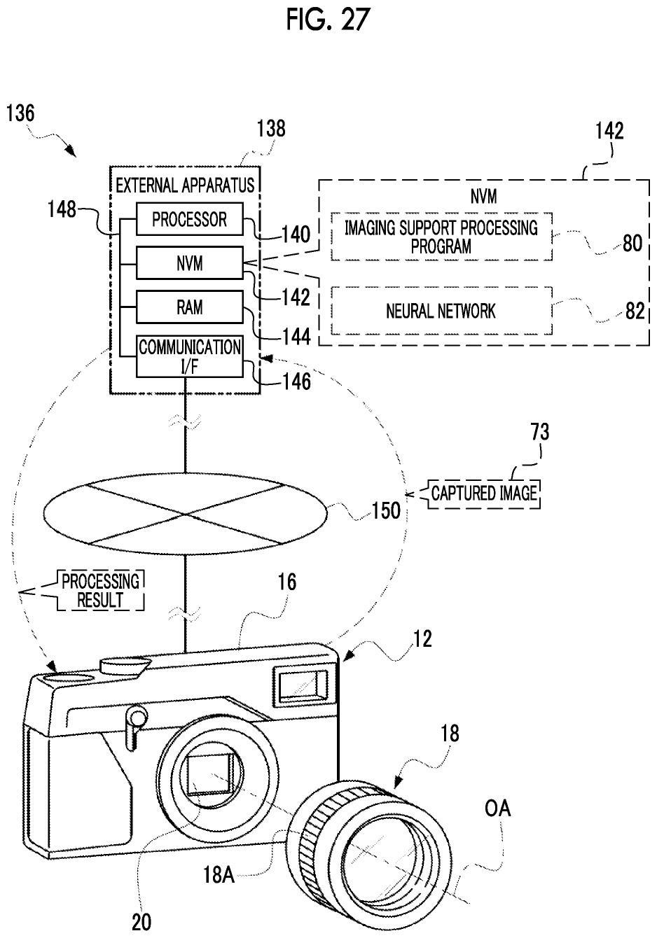

In the each of the above examples, although an example of the embodiment in which the imaging support processing is performed by the processor 62 of the controller 44 included in the imaging apparatus 12 has been described, the present disclosed technology is not limited to this, and a device that performs the imaging support processing may be provided outside the imaging apparatus 12. In this case, as an example shown in FIG. 27, the imaging system 136 may be used. The imaging system 136 includes the imaging apparatus 12 and an external apparatus 138. The external apparatus 138 is, for example, a server. The server is implemented by, for example, a mainframe. Here, although the mainframe is exemplified, this is only an example, and the server may be implemented by a cloud computing or implemented by network computing such as fog computing, edge computing, or grid computing. Here, although a server is exemplified as an example of the external apparatus 138, this is only an example, and at least one personal computer or the like may be used as the external apparatus 138 instead of the server.

The external apparatus 138 includes a processor 140, an NVM 142, a RAM 144, and a communication I/F 146, and the processor 140, the NVM 142, the RAM 144, and the communication I/F 146 are connected via a bus 148. The communication I/F 146 is connected to the imaging apparatus 12 via the network 150. The network 150 is, for example, the Internet. The network 150 is not limited to the Internet and may be a WAN and/or a LAN such as an intranet or the like.

The imaging support processing program 80 and the neural network 82 are stored in the NVM 142. The processor 140 executes the imaging support processing program 80 on the RAM 144. The processor 140 performs the above-described imaging support processing according to the imaging support processing program 80 executed on the RAM 144.

The imaging apparatus 12 transmits the captured image 73 to the external apparatus 138 via the network 150. The communication I/F 146 of the external apparatus 138 receives the captured image 73 via the network 150. The processor 140 performs the imaging support processing on the captured image 73 and transmits the processing result to the imaging apparatus 12 via the communication I/F 146. The imaging apparatus 12 receives the processing result, which is transmitted from the external apparatus 138, via the communication I/F 52 (see FIG. 2) and performs imaging based on the received processing result.

In the example shown in FIG. 27, the external apparatus 138 is an example of the “imaging support apparatus” according to the present disclosed technology, the processor 140 is an example of the “processor” according to the present disclosed technology, and the RAM 144 is an example of the “memory” according to the present disclosed technology.

Further, the imaging support processing may be performed in a distributed manner by a plurality of apparatuses including the imaging apparatus 12 and the external apparatus 138.

Further, in the above example, although an example of the embodiment in which the processor 62 is implemented by a CPU and a GPU has been described, the present disclosed technology is not limited to this, and the processor 62 may be a processor implemented by at least one CPU, at least one GPU, at least one GPGPU, and/or at least one TPU.

Further, in the above example, although the focus control, the intensive exposure control, and the intensive white balance control are exemplified as the first specification processing (see FIG. 10), the present disclosed technology is not limited to this, and various image processing such as high color tone adjustment processing according to an imaging scene, shadow tone adjustment processing according to the imaging scene, color adjustment processing according to the imaging scene, and/or moire correction processing may be performed as the first specification processing, and these image processing may be performed as the second specification processing (see FIG. 13).

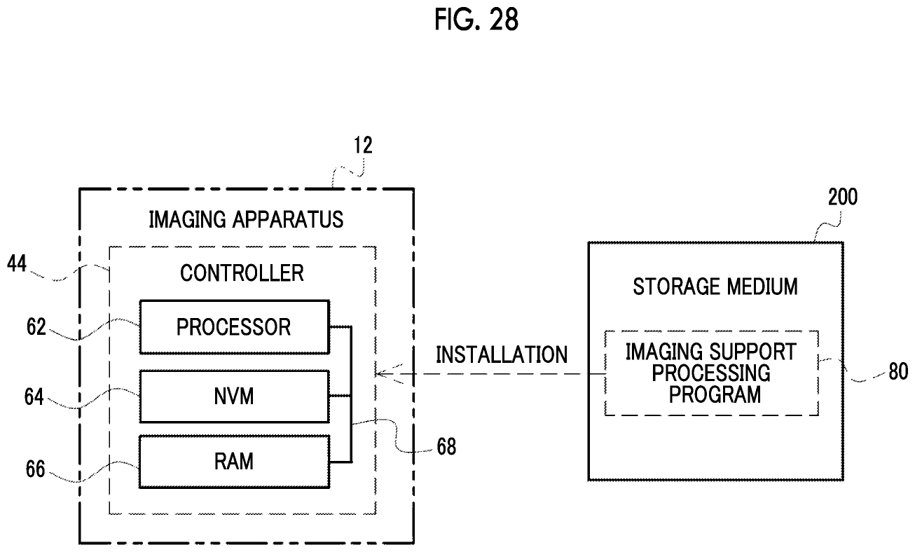

In the above example, although an example of the embodiment in which the imaging support processing program 80 is stored in the NVM 64 has been described, the present disclosed technology is not limited to this. For example, as shown in FIG. 28, the imaging support processing program 80 may be stored in a storage medium 200 such as an SSD or a USB memory. The storage medium 200 is a portable non-temporary storage medium. The imaging support processing program 80, which is stored in the storage medium 200, is installed in the controller 44 of the imaging apparatus 12. The processor 62 executes the imaging support processing according to the imaging support processing program 80.

Further, the imaging support processing program 80 may be stored in the storage device such as another computer or a server device connected to the imaging apparatus 12 via the network (not shown), the imaging support processing program 80 may be downloaded in response to the request of the imaging apparatus 12, and the imaging support processing program 80 may be installed in the controller 44.

It is not necessary to store all of the imaging support processing programs 80 in the storage device such as another computer or a server device connected to the imaging apparatus 12 or the NVM 64, and a part of the imaging support processing program 80 may be stored.

Further, although the imaging apparatus 12 shown in FIG. 2 has a built-in controller 44, the present disclosed technology is not limited to this, for example, the controller 44 may be provided outside the imaging apparatus 12.

In the above example, although the controller 44 is exemplified, the present disclosed technology is not limited to this, and a device including an ASIC, FPGA, and/or PLD may be applied instead of the controller 44. Further, instead of the controller 44, a combination of a hardware configuration and a software configuration may be used.

As a hardware resource for executing the imaging support processing described in the above example, the following various processors can be used. Examples of the processor include software, that is, a CPU, which is a general-purpose processor that functions as a hardware resource for executing the imaging support processing by executing a program. Further, examples of the processor include a dedicated electric circuit, which is a processor having a circuit configuration specially designed for executing specification processing such as FPGA, PLD, or ASIC. A memory is built-in or connected to any processor, and each processor executes the imaging support processing by using the memory.

The hardware resource for executing the imaging support processing may be configured with one of these various processors or may be configured with a combination (for example, a combination of a plurality of FPGAs or a combination of a CPU and an FPGA) of two or more processors of the same type or different types. Further, the hardware resource for executing the imaging support processing may be one processor.

As an example of configuring with one processor, first, one processor is configured with a combination of one or more CPUs and software, and there is an embodiment in which this processor functions as a hardware resource for executing the imaging support processing. Secondly, as typified by SoC, there is an embodiment in which a processor that implements the functions of the entire system including a plurality of hardware resources for executing the imaging support processing with one IC chip is used. As described above, the imaging support processing is implemented by using one or more of the above-mentioned various processors as a hardware resource.

Further, as the hardware-like structure of these various processors, more specifically, an electric circuit in which circuit elements such as semiconductor elements are combined can be used. Further, the above-mentioned imaging support processing is only an example. Therefore, it goes without saying that unnecessary steps may be deleted, new steps may be added, or the processing order may be changed within a range that does not deviate from the purpose.

The contents described above and the contents shown in the illustration are detailed explanations of the parts related to the present disclosed technology and are only an example of the present disclosed technology. For example, the description related to the configuration, function, action, and effect described above is an example related to the configuration, function, action, and effect of a portion according to the present disclosed technology. Therefore, it goes without saying that unnecessary parts may be deleted, new elements may be added, or replacements may be made to the contents described above and the contents shown in the illustration, within the range that does not deviate from the purpose of the present disclosed technology. Further, in order to avoid complications and facilitate understanding of the parts of the present disclosed technology, in the contents described above and the contents shown in the illustration, the descriptions related to the common technical knowledge or the like that do not require special explanation in order to enable the implementation of the present disclosed technology are omitted.

In the present specification, “A and/or B” is synonymous with “at least one of A or B”. That is, “A and/or B” means that it may be only A, it may be only B, or it may be a combination of A and B. Further, in the present specification, in a case where three or more matters are connected and expressed by “and/or”, the same concept as “A and/or B” is applied.

All documents, patent applications, and technical standards described in the present specification are incorporated in the present specification by reference to the same extent in a case where it is specifically and individually described that the individual documents, the patent applications, and the technical standards are incorporated by reference.

What is claimed is:

1. An imaging support apparatus comprising:
a processor; and
a memory built into or connected to the processor,
wherein the processor is configured to:
input a captured image to a neural network to cause the neural network to identify a subject that is included in the captured image; and
perform imaging-related processing according to an influence degree on identification with the neural network performed with respect to the captured image.

2. The imaging support apparatus according to claim 1,
wherein the processor is configured to perform division processing of dividing the captured image into a plurality of regions according to the influence degree.

3. The imaging support apparatus according to claim 2,
wherein the imaging-related processing includes first processing of outputting first data for displaying the plurality of regions on a first display in different manners according to the influence degree.

4. The imaging support apparatus according to claim 3,
wherein the first data is data for displaying the captured image on the first display and data for displaying the plurality of regions in a state of being combined with the captured image in different manners according to the influence degree.

5. The imaging support apparatus according to claim 2,
wherein the imaging-related processing includes second processing on a first region that corresponds to a region, from among the plurality of regions, having the influence degree equal to or higher than a first threshold value.

6. The imaging support apparatus according to claim 2,
wherein the imaging-related processing includes third processing of using data, as a reference, related to a region, from among the plurality of regions, having the influence degree equal to or higher than a second threshold value.

7. The imaging support apparatus according to claim 2,
wherein the processor is configured to perform the imaging-related processing based on a classification result obtained by classifying the plurality of regions according to the influence degree.

8. The imaging support apparatus according to claim 7,
wherein the processor is configured to perform detection processing of detecting a target subject based on the captured image and tracking processing of tracking the target subject based on the captured image, and
the imaging-related processing includes fourth processing of performing the tracking processing based on the classification result in a case where detection of the target subject using the detection processing is interrupted.

9. The imaging support apparatus according to claim 1,
wherein the processor is configured to selectively perform detection processing of detecting a target subject based on the captured image and tracking processing of tracking the target subject based on the captured image, and
the imaging-related processing includes fifth processing of switching from the detection processing to the tracking processing in a case where the influence degree is equal to or higher than a third threshold value.

10. The imaging support apparatus according to claim 1,
wherein the processor is configured to selectively perform detection processing of detecting a target subject based on the captured image and tracking processing of tracking the target subject based on the captured image, and
the imaging-related processing includes fifth processing of switching from the detection processing to the tracking processing based on a distribution state in which the influence degree in the captured image is equal to or higher than a third threshold value.

11. The imaging support apparatus according to claim 8,
wherein a tracking target region where a tracking target is specifiable using the tracking processing is narrower than a detection target region where a detection target is specifiable using the detection processing.

12. The imaging support apparatus according to claim 11,
wherein the imaging-related processing includes sixth processing of outputting second data for displaying, on a second display, a first composite image, which is obtained by combining the captured image and detection target region specification information in which the detection target region is specifiable, and a second composite image, which is obtained by combining the captured image and tracking target region specification information in which the tracking target region is specifiable.

13. The imaging support apparatus according to claim 12,
wherein the detection target region specification information is information including a first frame in which the detection target region is specifiable, and
the tracking target region specification information is information including a second frame in which the tracking target region is specifiable.

14. The imaging support apparatus according to claim 1,
wherein in a case where the captured image includes a plurality of subject images showing a plurality of subjects, the imaging-related processing includes seventh processing of selecting one subject from among the plurality of subjects based on at least one of the influence degree or a distribution state of the influence degrees.

15. The imaging support apparatus according to claim 14,
wherein the plurality of subjects are subjects of the same type.

16. The imaging support apparatus according to claim 1,
wherein the processor is configured to cause the neural network to identify a single subject class.

17. The imaging support apparatus according to claim 1,
wherein the processor is configured to perform first periodic processing of causing the neural network to identify the subject in a first period and second periodic processing of causing the neural network to identify the subject in a second period, which is longer than the first period, according to the influence degree.

18. The imaging support apparatus according to claim 1,
wherein the influence degree is derived based on an output of an interlayer of the neural network.

19. The imaging support apparatus according to claim 1,
wherein the neural network includes a plurality of interlayers, and
the influence degree is derived based on an output of an interlayer selected from the plurality of interlayers.

20. An imaging apparatus comprising:
a processor; and
an image sensor,
wherein the processor is configured to:
input a captured image, which is obtained by being captured by the image sensor, to a neural network to cause the neural network to identify a subject that is included in the captured image as an image; and
perform imaging-related processing according to an influence degree on identification with the neural network performed with respect to the captured image.

21. An imaging support method comprising:
inputting a captured image to a neural network to cause the neural network to identify a subject that is included in the captured image as an image; and
performing imaging-related processing according to an influence degree on identification with the neural network performed with respect to the captured image.

22. A non-transitory computer-readable storage medium storing a program executable by a computer to perform a process comprising:
inputting a captured image to a neural network to cause the neural network to identify a subject that is included in the captured image as an image; and
performing imaging-related processing according to an influence degree on identification with the neural network performed with respect to the captured image.
